(19) United States
(12) Patent Application Publication
(10) Pub. No.: US 2026/0023204 A1
(43) Pub. Date: Jan. 22, 2026

(54) IMAGE DISPLAY APPARATUS AND AR GLASSES

(71) Applicant: FUJIFILM Corporation, Tokyo (JP)

(72) Inventor: Hiroshi SATO, Minamiashigara-shi (JP)

(73) Assignee: FUJIFILM Corporation, Tokyo (JP)

(21) Appl. No.: 19/340,895

(22) Filed: Sep. 26, 2025

Related U.S. Application Data
(63) Continuation of application No. PCT/JP2024/015277, filed on Apr. 17, 2024.

(30) Foreign Application Priority Data
Apr. 18, 2023 (JP) 2023-067815

(51) Int. Cl. G02B 5/30; G02B 27/01; G02B 27/42

(52) U.S. Cl. CPC G02B 5/3016; G02B 27/0172; G02B 27/4205; G02B 27/4261; G02B 2027/0118; G02B 2027/0178

(57) ABSTRACT

An image display apparatus with reduced brightness unevenness and AR glasses including the apparatus are provided. The apparatus comprises an image projection element and a reflective polarization diffraction element that reflects the projected image. The polarization diffraction element includes a cholesteric liquid crystal layer formed by immobilizing a cholesteric liquid crystalline phase. The layer has an alignment pattern in which an optical axis orientation continuously rotates in at least one in-plane direction. When a 180° rotation length in the alignment pattern is set as a single period, the layer includes a region where the period length decreases away from the projection element, and regions where the helical structure pitch varies in-plane.

### CROSS-REFERENCE TO RELATED APPLICATIONS

This application is a Continuation of PCT International Application No. PCT/JP2024/015277 filed on Apr. 17, 2024, which claims priority under 35 U.S.C. § 119(a) to Japanese Patent Application No. 2023-067815 filed on Apr. 18, 2023. The above applications are hereby expressly incorporated by reference, in their entirety, into the present application.

### BACKGROUND OF THE INVENTION

### 1. Field of the Invention

The present invention relates to an image display apparatus that is used in AR glasses or the like and AR glasses including the image display apparatus.

### 2. Description of the Related Art

Recently, an image display apparatus such as augmented reality (AR) glasses or a head-up display (HUD) that displays augmented reality by displaying a virtual image such as various images or various information to be superimposed on a scene (real scene) that is actually being seen has been put into practice.

The AR glasses are also called smart glasses.

For example, WO2021/132063A discloses a technique relating to an image display apparatus including: a display element; and a reflective polarization diffraction element that reflects an image displayed by the display element, in which the polarization diffraction element has a region where a period of a diffraction structure decreases in a predetermined direction.

### SUMMARY OF THE INVENTION

The present inventors further investigated an image display apparatus with reference to the technique described in WO2021/132063A, and found that further improvement is required for brightness unevenness of an image to be observed, that is, a phenomenon where there is a difference in brightness (light amount) in a plane of the display image.

Under the above-described circumstances, an object of the present invention is to provide an image display apparatus having small brightness unevenness of an image to be observed, and AR glasses including this image display apparatus.

The present inventors have found that the above-described objects can be achieved by the following configurations.

[1] An image display apparatus comprising:
an image projection element; and
a reflective polarization diffraction element that reflects an image projected by the image projection element,
in which the polarization diffraction element includes a cholesteric liquid crystal layer obtained by immobilizing a cholesteric liquid crystalline phase,
the cholesteric liquid crystal layer has a liquid crystal alignment pattern in which an orientation of an optical axis derived from a liquid crystal compound changes while continuously rotating in at least one in-plane direction,
in a case where a length over which the orientation of the optical axis derived from the liquid crystal compound in the one direction of the liquid crystal alignment pattern rotates by 180° is set as a single period, the cholesteric liquid crystal layer has a region where the length of the single period decreases in an in-plane direction away from the image projection element, and
the cholesteric liquid crystal layer has regions where a pitch of a helical structure in the cholesteric liquid crystal layer varies in a plane.

[2] The image display apparatus according to [1],
in which the cholesteric liquid crystal layer has a region where the length of the single period decreases in the in-plane direction away from the image projection element and the pitch of the helical structure in the cholesteric liquid crystal layer increases.

[3] The image display apparatus according to [1] or [2],
in which the cholesteric liquid crystal layer has a region where the length of the single period is less than 1.0 μm.

[4] The image display apparatus according to any one of [1] to [3],
in which the polarization diffraction element includes a first cholesteric liquid crystal layer and a second cholesteric liquid crystal layer each of which is provided in the cholesteric liquid crystal layer, and
a rotation direction of the orientation of the optical axis that continuously rotates in the one direction in the liquid crystal alignment pattern of the first cholesteric liquid crystal layer is opposite to a rotation direction of the orientation of the optical axis that continuously rotates in the one direction in the liquid crystal alignment pattern of the second cholesteric liquid crystal layer, and
a turning direction of the helical structure in the first cholesteric liquid crystal layer is opposite to a turning direction of the helical structure in the second cholesteric liquid crystal layer.

[5] The image display apparatus according to [4],
in which a wavelength range of light that is selectively reflected from the first cholesteric liquid crystal layer overlaps a wavelength range of light that is selectively reflected from the second cholesteric liquid crystal layer.

[6] The image display apparatus according to any one of [1] to [3],
in which the polarization diffraction element includes a first cholesteric liquid crystal layer, a second cholesteric liquid crystal layer, and a third cholesteric liquid crystal layer each of which is provided in the cholesteric liquid crystal layer,
in all of the first cholesteric liquid crystal layer, the second cholesteric liquid crystal layer, and the third cholesteric liquid crystal layer, lengths of the single periods are different from each other, and pitches of the helical structures are different from each other at any one in-plane point of the polarization diffraction element,
in a case where the lengths of the single periods of the first cholesteric liquid crystal layer, the second cholesteric liquid crystal layer, and the third cholesteric liquid crystal layer at the one in-plane point are represented by Λ₁, Λ₂, and Λ₃, respectively, Λ₁<Λ₂<Λ₃ is satisfied,
the first cholesteric liquid crystal layer has a region where blue light is diffracted,
the second cholesteric liquid crystal layer has a region where green light is diffracted, and
the third cholesteric liquid crystal layer has a region where red light is diffracted.

[7] The image display apparatus according to [6],
in which a rotation direction of the orientation of the optical axis that continuously rotates in the one direction in the liquid crystal alignment pattern of the first cholesteric liquid crystal layer is opposite to a rotation direction of the orientation of the optical axis that continuously rotates in the one direction in the liquid crystal alignment pattern of the second cholesteric liquid crystal layer, and is the same as a rotation direction of the orientation of the optical axis that continuously rotates in the one direction in the liquid crystal alignment pattern of the third cholesteric liquid crystal layer, and
a turning direction of the helical structure in the first cholesteric liquid crystal layer is opposite to a turning direction of the helical structure in the second cholesteric liquid crystal layer, and is the same as a turning direction of the helical structure in the third cholesteric liquid crystal layer.

[8] AR glasses comprising:
the image display apparatus according to any one of [1] to [7].

According to the present invention, it is possible to provide an image display apparatus having small brightness unevenness of an image to be observed, and AR glasses including this image display apparatus.

### BRIEF DESCRIPTION OF THE DRAWINGS

FIG. 1 is a diagram conceptually showing an example of a configuration of an image display apparatus according to the present invention.

FIG. 2 is a diagram conceptually showing an example of a polarization diffraction element in the cholesteric liquid crystal layer.

FIG. 3 is a plan view conceptually showing an example of the cholesteric liquid crystal layer.

FIG. 4 is a diagram conceptually showing a scanning electron microscope image of a cross section of the cholesteric liquid crystal layer shown in FIG. 2.

FIG. 5 is a conceptual diagram showing an action of the cholesteric liquid crystal layer shown in FIG. 2.

FIG. 6 is a diagram conceptually showing an example of a cholesteric liquid crystal layer having a liquid crystal alignment pattern.

FIG. 7 is a diagram conceptually showing another example of the cholesteric liquid crystal layer.

FIG. 8 is a diagram conceptually showing another example of the cholesteric liquid crystal layer.

FIG. 9 is a diagram conceptually showing an example of an exposure device that exposes an alignment film.

FIG. 10 is a diagram conceptually showing another example of a configuration of an image display apparatus according to the present invention.

FIG. 11 is a diagram conceptually showing another example of the configuration of the image display apparatus according to the present invention.

FIG. 12 is a diagram conceptually showing another example of the configuration of the image display apparatus according to the present invention.

### DESCRIPTION OF THE PREFERRED EMBODIMENTS

Hereinafter, an image display apparatus and AR glasses according to an embodiment of the present invention will be described in detail based on a preferable embodiment shown in the accompanying drawings.

In the present specification, numerical ranges represented by “to” include numerical values before and after “to” as lower limit values and upper limit values.

In the present specification, “(meth)acrylate” represents “either or both of acrylate and methacrylate”.

In the present specification, the meaning of “the same” includes a case where an error range is generally allowable in the technical field. In addition, in the present specification, the meaning of “all”, “entire”, or “entire surface” includes not only 100% but also a case where an error range is generally allowable in the technical field, for example, 99% or more, 95% or more, or 90% or more.

In the present specification, a selective reflection center wavelength refers to an average value of two wavelengths at which, in a case where a minimum value of a transmittance of a target object (member) is represented by Tₘᵢₙ (%), a half value transmittance: T_{1/2}(%) represented by the following expression is exhibited.

$$Expression for obtaining Half Value Transmittance : {T}_{1 / 2} = 100 - ( 100 - T min ) \div 2$$

In addition, “perpendicular” or “parallel” regarding an angle represents a range of the exact angle ±5°, and “the same” regarding an angle represents that a difference from the exact angle is less than 5 degrees unless specified otherwise. The difference from the exact angle is preferably less than 4 degrees and more preferably less than 3 degrees.

In the present specification, visible light refers to light having a wavelength which can be observed by human eyes among electromagnetic waves and refers to light in a wavelength range of 380 to 780 nm. Invisible light refers to light in a wavelength range of shorter than 380 nm or longer than 780 nm.

In addition, although not limited thereto, in visible light, light in a wavelength range of 420 to 490 nm refers to blue light, light in a wavelength range of 495 to 570 nm refers to green light, and light in a wavelength range of 620 to 750 nm refers to red light.

### [Image Display Apparatus]

An image display apparatus according to an embodiment of the present invention includes: an image projection element; and a reflective polarization diffraction element that reflects an image projected by the image projection element, in which the polarization diffraction element includes a cholesteric liquid crystal layer obtained by immobilizing a cholesteric liquid crystalline phase.

In the image display apparatus according to the embodiment of the present invention, the cholesteric liquid crystal layer has a liquid crystal alignment pattern in which an orientation of an optical axis derived from a liquid crystal compound changes while continuously rotating in at least one in-plane direction. Here, in a case where a length over which the orientation of the optical axis derived from the liquid crystal compound in the one direction of the liquid crystal alignment pattern rotates by 180° is set as a single period, the cholesteric liquid crystal layer has a region where the length of the single period decreases in an in-plane direction away from the image projection element.

Further, in the image display apparatus according to the embodiment of the present invention, the cholesteric liquid crystal layer has regions where a pitch of a helical structure in the cholesteric liquid crystal layer varies in a plane.

Although described in detail below, with the image display apparatus according to the embodiment of the present invention having the above-described structure, even in a case where incidence light is reflected at different angles in different in-plane regions of the polarization diffraction element, brightness unevenness in a plane of an image to be observed by a user at an observation position can be further reduced.

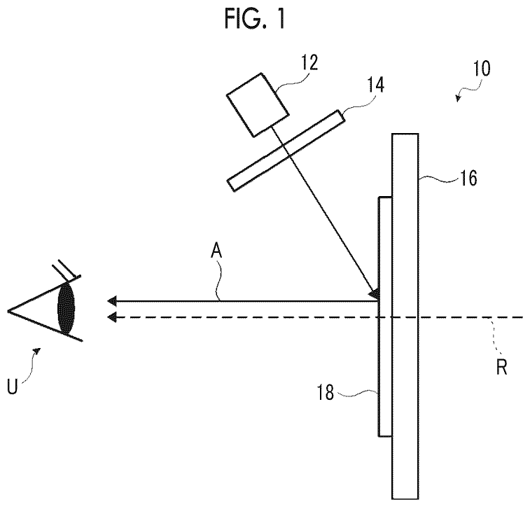

FIG. 1 conceptually shows an example of a configuration of the image display apparatus according to the embodiment of the present invention.

The image display apparatus according to the embodiment of the present invention is an image display apparatus that displays augmented reality where a virtual image A is superimposed on a real scene R and is used in AR glasses, a HUD, a head-mounted display (HMD), or the like.

An image display apparatus 10 shown in FIG. 1 includes an image projection element 12, a retardation plate 14, a transparent substrate 16, and a polarization diffraction element 18. The polarization diffraction element 18 includes a cholesteric liquid crystal layer obtained by immobilizing a cholesteric liquid crystalline phase.

In the image display apparatus 10, the real scene R transmits through the transparent substrate 16 and the polarization diffraction element 18 to be observed by the user U.

On the other hand, although described below in detail, a virtual image A (projection image) projected by the image projection element 12 is converted into, for example, predetermined circularly polarized light by the retardation plate 14, and is diffracted by the polarization diffraction element 18 to be reflected to the user U, and is observed by the user U.

As a result, the user U of the image display apparatus 10 observes augmented reality where the virtual image A is superimposed on the real scene R.

The image display apparatus 10 is, for example, AR glasses.

Hereinafter, each of the components in the image display apparatus according to the embodiment of the present invention will be described.

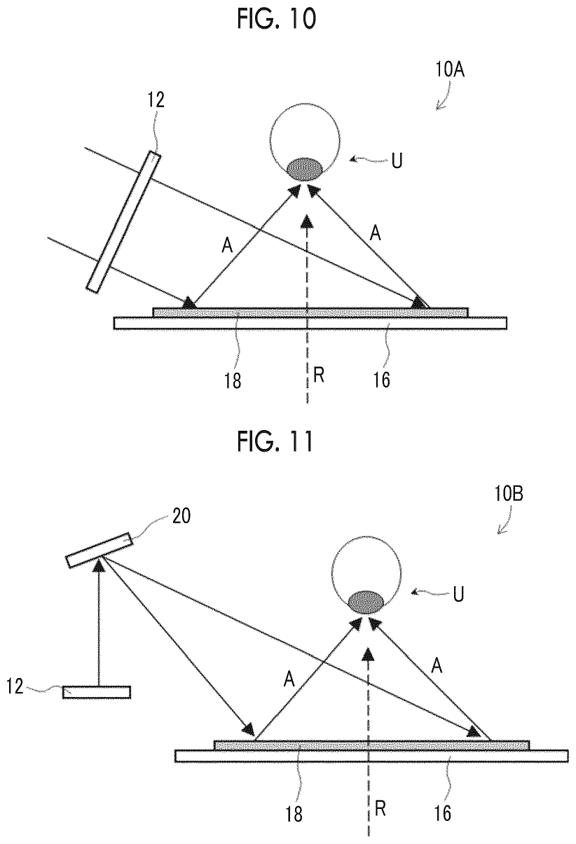

The image display apparatus according to the embodiment of the present invention is not limited to the configuration of the image display apparatus 10 shown in FIG. 1, and may include other configurations as long as it includes the image projection element and the reflective polarization diffraction element including the predetermined cholesteric liquid crystal layer. Examples of the other examples of the configuration of the image display apparatus according to the embodiment of the present invention include image display apparatuses shown in FIGS. 10 to 12 below.

### [Image Projection Element]

In the image display apparatus 10 according to the embodiment of the present invention, the image projection element 12 projects (displays) the virtual image A. In other words, the image projection element 12 projects an image that forms the virtual image A.

In the present invention, the image projection element 12 is not limited, and various well-known projection elements (display elements or projectors) used for AR glasses or the like can be used.

Examples of the image projection element 12 include a laser light source, a scanning projection element that deflects a light beam modulated by a spatial light modulator (SLM) according to an image for two-dimensional scanning, a liquid crystal display (LCD), an organic electroluminescent display (OLED (organic light emitting diode)), a liquid crystal on silicon (LCOS) display, and a digital light processing (DLP) display.

As the spatial light modulator, a well-known light deflection element, for example, a micro electro mechanical systems (MEMS) type spatial light modulator, an optical element (PLZT element) that modulates transmitted light using an electro-optic effect, or a liquid crystal shutter array such as a liquid crystal light shutter (FLC) can be used. The spatial light modulator may be any of a reflective type or a transmissive type.

The MEMS type spatial light modulator refers to a spatial light modulator that is driven due to an electromechanical operation using an electrostatic force. For example, all of the well-known MEMS light deflection elements (for example, a MEMS scanner (light scanner), a MEMS light deflector, a MEMS mirror, or a digital micromirror device (DMD)) that swing a mirror using a piezoelectric actuator to deflect light (deflection scanning), for example, a MEMS light deflection element described in JP2012-208352A, a MEMS light deflection element described in JP2014-134642A, or a MEMS light deflection element described in JP2015-022064A can be used.

In the image display apparatus 10 according to the embodiment of the present invention, it is preferable that the image projection element 12 projects the virtual image A of linearly polarized light.

Accordingly, in a case where a projection element using a laser light source that emits linearly polarized light or a projection element such as an LCD that projects an image of linearly polarized light is used, the image projection element 12 can be formed using the projection element alone.

On the other hand, in a case where a projection element such as an OLED that projects an image of unpolarized light is used, it is preferable that the image projection element 12 is formed using a display and a polarizer in combination to project an image of linearly polarized light.

The polarizer is not particularly limited, and various well-known polarizers can be used. Accordingly, as the polarizer, any of an iodine polarizer, a dye-based polarizer using a dichroic dye, a polyene polarizer, or a polarizer formed of a material that polarizes light by UV absorption may be used.

As described above, the image display apparatus 10 in the example shown in the drawing is, for example, AR glasses. FIG. 1 is a diagram conceptually showing the image display apparatus 10 in a state where the user U wears AR glasses in case of being seen from the top (the top side among the top side and bottom side).

In the image display apparatus 10, the image projection element 12 is mounted on, for example, temples of the AR glasses.

In a case where a display that displays a surface-shaped image on a display surface of LCD, an OLED, or the like is used as the image projection element 12, optionally, a lens that focuses the virtual image A projected by the image projection element 12 may be provided between the image projection element 12 and the retardation plate 14.

As the lens, a well-known condenser lens that focuses the virtual image A projected by the image projection element 12 can be used.

### [Retardation Plate]

The retardation plate 14 converts the virtual image A of linearly polarized light projected by the image projection element 12 into the virtual image A of predetermined circularly polarized light corresponding to the polarization diffraction element 18.

In the image display apparatus 10 in the example shown in the drawing, the retardation plate 14 converts, for example, the virtual image A of linearly polarized light into the virtual image A of right circularly polarized light.

It is preferable that the retardation plate 14 is a λ/4 plate (¼ wave plate).

As is well known, the cholesteric liquid crystalline phase selectively reflects right or left circularly polarized light. Accordingly, by using the λ/4 plate as the retardation plate 14, the virtual image A of linearly polarized light is suitably converted into the virtual image A of right circularly polarized light such that the utilization efficiency of the virtual image A projected by the image projection element 12 can be improved.

As the retardation plate 14, a well-known retardation plate can be used. For example, various well-known retardation plates, for example, a cured layer or a structural birefringent layer of a polymer or a liquid crystal compound can be used.

As the retardation plate 14, a retardation plate in which a plurality of retardation plates are laminated to effectively exhibit a desired action is also preferable. As a λ/4 plate, a retardation plate in which a plurality of retardation plates are laminated to effectively function as a λ/4 plate is also preferably used. For example, a broadband λ/4 plate described in WO2013/137464A in which a λ/2 plate and λ/4 plate are used in combination can handle with incidence light in a wide wavelength range and can be preferably used.

Further, it is preferable that the retardation plate 14 has reverse wavelength dispersibility. In a case where the retardation plate 14 has reverse wavelength dispersibility, incidence light in a wide wavelength range can be handled.

The retardation plate 14 is disposed in a state where a direction of a slow axis is adjusted such that the linearly polarized light is converted into circularly polarized light having a desired turning direction depending on a polarization direction of the linearly polarized light of the image projected by the image projection element 12.

In the image display apparatus according to the embodiment of the present invention, the retardation plate 14 is provided as a preferable aspect. Accordingly, depending on light (projection light) emitted from the image projection element, the retardation plate does not need to be present between the image projection element and the polarization diffraction element of the image display apparatus.

### [Transparent Substrate]

The transparent substrate 16 supports the polarization diffraction element 18.

The transparent substrate 16 is not particularly limited, and substrates formed of glass or various well-known materials, for example, a resin material such as a (meth)acrylic resin, a triacetyl cellulose (TAC) film, polyethylene terephthalate (PET), polycarbonate, polyvinyl chloride, or polyolefin can be used as long as they have sufficient transparency for observing the real scene R and can support the polarization diffraction element 18.

As described above, the image display apparatus 10 is, for example, AR glasses. In the image display apparatus 10, the transparent substrate 16 is, for example, a spectacle lens of AR glasses.

In the image display apparatus according to the embodiment of the present invention, the transparent substrate 16 is provided as a preferable aspect.

Accordingly, in a case where a member that has sufficient transparency for observing the real scene R and can support the polarization diffraction element 18 is present in a use environment of the image display apparatus according to the embodiment of the present invention, the polarization diffraction element 18 may be supported by this member to configure the image display apparatus according to the embodiment of the present invention.

### [Polarization Diffraction Element]

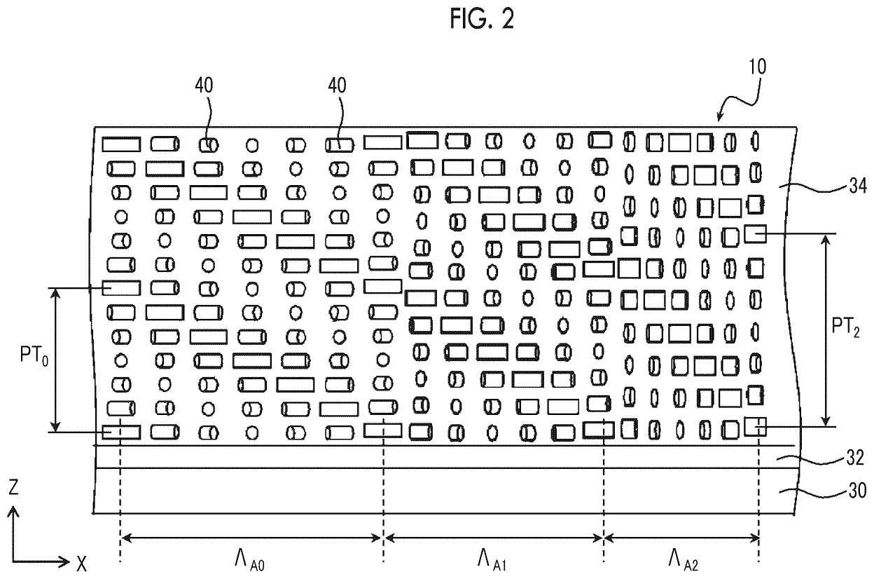

FIG. 2 conceptually shows an example of the polarization diffraction element 18. The polarization diffraction element 18 includes a support 30, an alignment film 32, and a cholesteric liquid crystal layer 34.

The cholesteric liquid crystal layer 34 is obtained by immobilizing a cholesteric liquid crystalline phase. As is well known, the cholesteric liquid crystalline phase has a helical structure in which a liquid crystal compound is helically turned and laminated, selectively reflects right circularly polarized light or left circularly polarized light in a predetermined wavelength range, and allows transmission of the other light.

For example, the cholesteric liquid crystal layer 34 in the example shown in the drawing selectively reflects right circularly polarized light of green light and allows transmission of the other light.

The polarization diffraction element 18 shown in FIG. 2 includes the support 30, the alignment film 32, and the liquid crystal layer 34. However, the present invention is not limited to this configuration.

For example, the polarization diffraction element may consist of only the alignment film 32 and the liquid crystal layer 34 by peeling off the support 30 after forming the liquid crystal layer 34. Alternatively, for example, the polarization diffraction element may consist of only the liquid crystal layer 34 by peeling off the support 30 and the alignment film 32 after forming the liquid crystal layer 34.

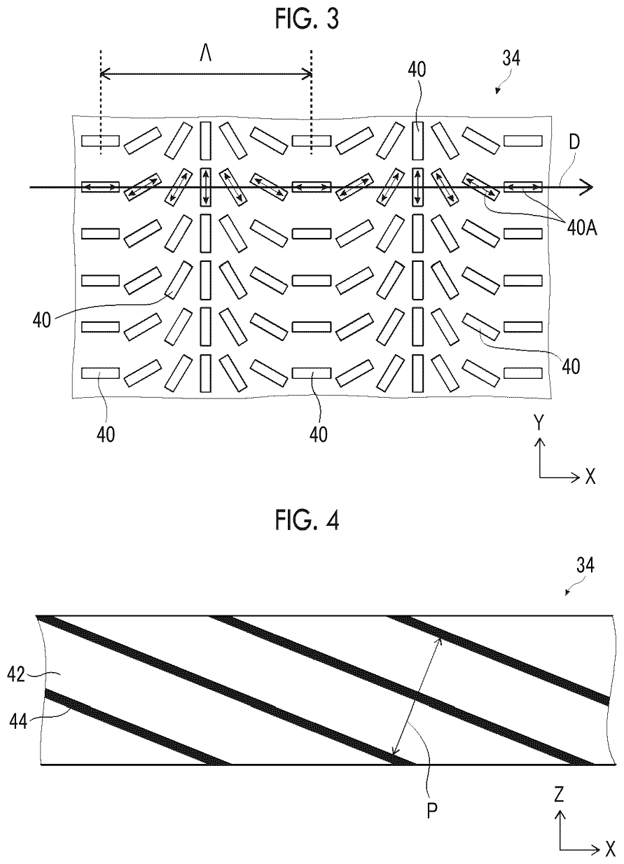

Hereinafter, the polarization diffraction element will be described using FIGS. 2 and 3.

FIG. 2 is a diagram conceptually showing an example of the polarization diffraction element. As described above, the polarization diffraction element includes the support 30, the alignment film 32, and the cholesteric liquid crystal layer 34 as a liquid crystal diffraction element that exhibits an action as a reflective polarization diffraction element.

FIG. 3 is a plan view conceptually showing an example of the cholesteric liquid crystal layer 34. In the cholesteric liquid crystal layer 34 shown in FIG. 3, the alignment state of a liquid crystal compound 40 in a plane of a main surface is schematically shown. The main surface is the maximum surface of a sheet-shaped material (a film, a plate-shaped material, or a layer).

In the following description, it is assumed that a main surface of the cholesteric liquid crystal layer 34 is an X-Y plane and a cross-section perpendicular to the X-Y plane is an X-Z plane. That is, FIG. 2 corresponds to a schematic diagram of the X-Z plane of the cholesteric liquid crystal layer 34, and FIG. 3 corresponds to a schematic diagram of the X-Y plane of the cholesteric liquid crystal layer 34.

As shown in FIG. 2, the cholesteric liquid crystal layer 34 is a layer obtained by cholesteric alignment of the liquid crystal compound 40. In addition, FIGS. 2 and 3 show an example in which the liquid crystal compound forming the cholesteric liquid crystal layer is a rod-like liquid crystal compound.

In the following description, the cholesteric liquid crystal layer will also be referred to as “liquid crystal layer”.

### <Support>

The support 30 supports the alignment film 32 and the liquid crystal layer 34.

As the support 30, various sheet-shaped materials (films or plate-shaped materials) can be used as long as they can support the alignment film 32 and the liquid crystal layer 34.

A transmittance of the support 30 with respect to corresponding light is preferably 50% or more, more preferably 70% or more, and still more preferably 85% or more.

The thickness of the support 30 is not particularly limited and may be appropriately set depending on the use of the polarization diffraction element, a material for forming the support 30, and the like in a range where the alignment film 32 and the liquid crystal layer 34 can be supported.

The thickness of the support 30 is preferably 1 to 2000 μm, more preferably 3 to 500 μm, and still more preferably 5 to 250 sm.

The support 30 may have a monolayer structure or a multi-layer structure.

In a case where the support 30 has a monolayer structure, examples thereof include supports formed of glass, triacetyl cellulose (TAC), polyethylene terephthalate (PET), polycarbonates, polyvinyl chloride, acryl, polyolefin, and the like. In a case where the support 30 has a multi-layer structure, examples thereof include a support including: one of the above-described supports having a monolayer structure that is provided as a substrate; and another layer that is provided on a surface of the substrate.

### <Alignment Film>

In the polarization diffraction element, the alignment film 32 is formed on a surface of the support 30.

The alignment film 32 is an alignment film for aligning the liquid crystal compound 40 to a predetermined liquid crystal alignment pattern during the formation of the liquid crystal layer 34.

Although described below, in the present invention, the liquid crystal layer 34 has a liquid crystal alignment pattern in which an orientation of an optical axis 40A (refer to FIG. 3) derived from the liquid crystal compound 40 changes while continuously rotating in one in-plane direction. In the following description, “the orientation of the optical axis 40A rotates” will also be simply referred to as “the optical axis 40A rotates”.

As described above, the liquid crystal layer 34 acts as a reflective polarization diffraction element. In the liquid crystal alignment pattern of the liquid crystal layer 34, a single period over which the optical axis 40A rotates by 180° in one direction in which the optical axes 40A rotates is a period of the diffraction structure. In addition, the liquid crystal layer 34 has a region in which the length of the single period in which the optical axis 40A rotates by 180° in the liquid crystal alignment pattern gradually decreases in a direction away from the image projection element 12.

Accordingly, the alignment film 32 is formed such that the liquid crystal layer 34 can form the liquid crystal alignment pattern.

As the alignment film 32, various well-known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, or methyl stearate.

The alignment film 32 formed by a rubbing treatment can be formed by rubbing a surface of a polymer layer with paper or fabric in a given direction multiple times.

As the material used for the alignment film 32, for example, a material for forming polyimide, polyvinyl alcohol, a polymer having a polymerizable group described in JP1997-152509A (JP-H9-152509A), or an alignment film such as JP2005-097377A, JP2005-099228A, and JP2005-128503A is preferable.

In the polarization diffraction element 18, for example, the alignment film 32 can be suitably used as a so-called photo-alignment film obtained by irradiating a photo-alignment material with polarized light or non-polarized light. That is, in the polarization diffraction element, a photo-alignment film that is formed by applying a photo-alignment material to the support 30 is suitably used as the alignment film 32.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the alignment film that can be used in the present invention include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-012823A.

Among these, an azo compound, a photocrosslinking polyimide, a photocrosslinking polyamide, a photocrosslinking polyester, a cinnamate compound, or a chalcone compound is suitably used.

The thickness of the alignment film 32 is not particularly limited. The thickness with which a required alignment function can be obtained may be appropriately set depending on the material for forming the alignment film 32.

The thickness of the alignment film 32 is preferably 0.01 to 5 μm and more preferably 0.05 to 2 μM.

A method of forming the alignment film 32 is not limited. Any one of various well-known methods corresponding to a material for forming the alignment film 32 can be used. For example, a method including: applying the alignment film 32 to a surface of the support 30; drying the applied alignment film 32; and exposing the alignment film 32 to laser light to form an alignment pattern can be used.

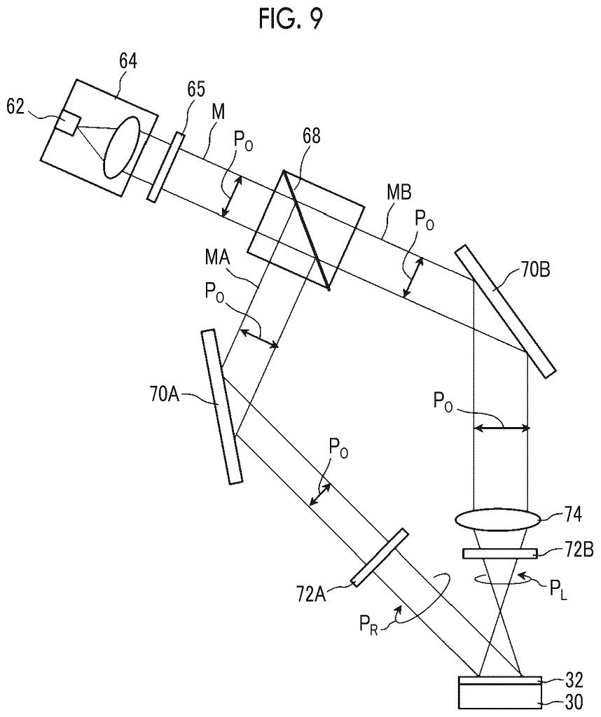

FIG. 9 conceptually shows an example of an exposure device that exposes the alignment film 32 to form an alignment pattern.

An exposure device 60 shown in FIG. 9 includes: a light source 64 including a laser 62; an λ/2 plate 65 that changes a polarization direction of laser light M emitted from the laser 62; a polarization beam splitter 68 that splits the laser light M emitted from the laser 62 into two beams MA and MB; mirrors 70A and 70B that are disposed on optical paths of the two split beams MA and MB; λ/4 plates 72A and 72B; and a lens 74 that is disposed on an optical path of the beam MB.

The light source 64 emits linearly polarized light P₀. The λ/4 plate 72A converts the linearly polarized light P₀ (beam MA) into right circularly polarized light P_{R}, and the λ/4 plate 72B converts the linearly polarized light P₀ (beam MB) into left circularly polarized light P_{L}. In addition, the lens 74 focuses the linearly polarized light P₀ (beam MB) before the linearly polarized light P₀ is incident into the λ/4 plate 72B.

The support 30 including the alignment film 32 on which the alignment pattern is not yet formed is disposed at an exposed portion, the two beams MA and MB intersect and interfere with each other on the alignment film 32, and the alignment film 32 is irradiated with and exposed to the interference light.

Due to the interference in this case, the polarized state of light with which the alignment film 32 is irradiated periodically changes according to interference fringes. As a result, an alignment film having an alignment pattern in which the alignment state periodically changes can be obtained. In the following description, this alignment film having the alignment pattern will also be referred to as “patterned alignment film”.

In the exposure device 60, by changing an intersecting angle α between the two beams MA and MB, the period of the alignment pattern can be adjusted. That is, by adjusting the intersecting angle α in the exposure device 60, in the liquid crystal alignment pattern in which the optical axis 40A derived from the liquid crystal compound 40 continuously rotates in the one direction, the length of the single period over which the optical axis 40A rotates by 180° in the one direction in which the optical axis 40A rotates can be adjusted.

In the exposure device 60, the single period in the liquid crystal alignment pattern in which the optical axis of the liquid crystal compound 40 continuously rotates by 180° in the one direction can be controlled by changing the refractive power of the lens 74 (the F-number of the lens 74), the focal length of the lens 74, the distance between the lens 74 and the alignment film 32, and the like.

In addition, by adjusting the refractive power of the lens 74 (the F-number of the lens 74), the length of the single period in the liquid crystal alignment pattern in the one direction in which the optical axis continuously rotates can be changed.

Specifically, the length of the single period in the liquid crystal alignment pattern in the one direction in which the optical axis continuously rotates can be changed depending on a light spread angle at which light is spread by the lens 74 due to interference with another light. More specifically, in a case where the refractive power of the lens 74 is weak, light is approximated to parallel light. Therefore, the length of the single period in the liquid crystal alignment pattern gradually decreases from the inner side toward the outer side, and the F-number increases. Conversely, in a case where the refractive power of the lens 74 becomes stronger, the length of the single period in the liquid crystal alignment pattern rapidly decreases from the inner side toward the outer side, and the F-number decreases.

Accordingly, by adjusting the intersecting angle α, the refractive power of the lens 74, the distance between the lens 74 and the alignment film 32, and the like according to a desired length of the single period, the alignment film 32 including the alignment pattern having the region in which the length of the single period gradually decreases in the direction away from the image projection element 12 can be formed.

The intersecting angle α between the two beams MA and MB refers to an angle between an optical axis (central axis) of the beam MA and an optical axis (central axis) of the beam MB, the beams MA and MB intersecting with each other in the alignment film 32 disposed in the exposure device 60.

By forming the cholesteric liquid crystal layer on the alignment film 32 having the alignment pattern in which the alignment state periodically changes, as described below, the liquid crystal layer 34 having the liquid crystal alignment pattern in which the optical axis 40A derived from the liquid crystal compound 40 continuously rotates in the one direction and having the region in which the length of the single period decreases in the direction away from the image projection element 12 can be formed.

In addition, by rotating the optical axes of the λ/4 plates 72A and 72B by 90°, respectively, the rotation direction of the optical axis 40A can be reversed.

As described above, the patterned alignment film has an alignment pattern to obtain the liquid crystal alignment pattern in which the liquid crystal compound is aligned such that the orientation of the optical axis of the liquid crystal compound in the liquid crystal layer formed on the patterned alignment film changes while continuously rotating in at least one in-plane direction.

In a case where an axis along an orientation in the direction in which the liquid crystal compound is aligned is an arrangement axis, it can be said that the patterned alignment film has an alignment pattern in which the orientation of the arrangement axis changes while continuously rotating in at least one in-plane direction. The arrangement axis of the patterned alignment film can be detected by measuring absorption anisotropy. For example, in a case where the amount of light transmitted through the patterned alignment film is measured by irradiating the patterned alignment film with linearly polarized light while rotating the patterned alignment film, it is observed that an orientation in which the light amount is the maximum or the minimum gradually changes in the one direction.

In the present invention, the alignment film 32 is provided as a preferable aspect and is not an essential configuration requirement in the polarization diffraction element in the image display apparatus according to the embodiment of the present invention.

For example, the following configuration can also be adopted, in which, by forming the alignment pattern on the support 30 using a method of rubbing the support 30, a method of processing the support 30 with laser light or the like, the liquid crystal layer has the liquid crystal alignment pattern in which the orientation of the optical axis 40A derived from the liquid crystal compound 40 changes while continuously rotating in at least one in-plane direction. That is, in the present invention, the support 30 may be made to function as the alignment film.

### <Cholesteric Liquid Crystal Layer (Liquid Crystal Layer)>

In the polarization diffraction element, the liquid crystal layer 34 is formed on a surface of the alignment film 32.

The liquid crystal layer 34 is a cholesteric liquid crystal layer obtained by immobilizing a cholesteric liquid crystalline phase, has a liquid crystal alignment pattern in which an orientation of an optical axis derived from a liquid crystal compound changes while continuously rotating in at least one in-plane direction, and has regions where a pitch of a helical structure in the cholesteric liquid crystal layer varies in a plane.

As conceptually shown in FIG. 2, the liquid crystal layer 34 has a helical structure in which the liquid crystal compound 40 is helically turned and laminated as in a cholesteric liquid crystal layer obtained by immobilizing a typical cholesteric liquid crystalline phase. In the helical structure, a configuration in which the liquid crystal compound 40 is helically rotated once (rotated by 360°) and laminated is set as one helical pitch of the helical structure (helical pitch), and plural pitches of the helically turned liquid crystal compound 40 are laminated.

As is well known, the cholesteric liquid crystalline phase exhibits selective reflectivity (wavelength-selective reflectivity) with respect to left or right circularly polarized light at a specific wavelength. Whether or not the reflected light is right circularly polarized light or left circularly polarized light is determined depending on a helical twisted direction (sense) of the cholesteric liquid crystalline phase. Regarding the selective reflection of the circularly polarized light by the cholesteric liquid crystalline phase, in a case where the helical twisted direction of the cholesteric liquid crystalline phase is right, right circularly polarized light is reflected, and in a case where the helical twisted direction of the cholesteric liquid crystalline phase is left, left circularly polarized light is reflected.

For example, as described above, in a case where the liquid crystal layer 34 has a selective reflection center wavelength in a green wavelength range and selectively reflects right circularly polarized light of green light, In the liquid crystal layer 34, the helical twisted direction of the cholesteric liquid crystalline phase is the right direction, right circularly polarized light G_{R} of green light is reflected, and transmission of the other light is allowed.

The turning direction of the cholesteric liquid crystalline phase can be adjusted by adjusting the kind of the liquid crystal compound that forms the cholesteric liquid crystal layer and/or the kind of the chiral agent to be added.

Here, in the liquid crystal layer 34, the liquid crystal compound 40 is aligned while continuously rotating in the one direction. Therefore, the liquid crystal layer 34 refracts (diffracts) and reflects incident circularly polarized light in a direction in which the orientation of the optical axis 40A continuously rotates. In this case, the diffraction direction varies depending on the turning direction of incident circularly polarized light.

That is, the liquid crystal layer 34 reflects right circularly polarized light or left circularly polarized light having a selective reflection wavelength and diffracts the reflected light.

This way, it is known that the cholesteric liquid crystalline phase exhibits selective reflectivity at a specific wavelength. A central wavelength of selective reflection (selective reflection center wavelength) λ depends on a pitch (=helical period) of the helical structure (hereinafter, also referred to as “helical pitch PT”) in the cholesteric liquid crystalline phase. More specifically, the selective reflection center wavelength λ satisfies a relationship of λ=n×PT with the helical pitch PT and an average refractive index n of the cholesteric liquid crystalline phase. Therefore, the selective reflection center wavelength can be adjusted by adjusting the helical pitch PT. The helical pitch PT of the cholesteric liquid crystalline phase depends on the kind of a chiral agent which is used in combination of a liquid crystal compound during the formation of the cholesteric liquid crystal layer, or the concentration of the chiral agent added. Therefore, a desired helical pitch PT can be obtained by adjusting the kind and concentration of the chiral agent.

Furthermore, the adjustment of the helical pitch PT is described in detail in FUJIFILM Research Report No. 50 (2005), p. 60 to 63. As a method of measuring a helical sense and a helical pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

In addition, a half-width Δλ (nm) of a selective reflection range (circularly polarized light reflection range) where selective reflection is exhibited depends on Δn of the cholesteric liquid crystalline phase and the helical pitch PT and satisfies a relationship of “Δλ=Δn×PT”. Therefore, the width of the selective reflection range can be controlled by adjusting Δn. Δn can be adjusted by adjusting a kind of a liquid crystal compound for forming the cholesteric liquid crystal layer and a mixing ratio thereof, and a temperature during alignment immobilization.

Accordingly, regarding the wavelength of light that is reflected (diffracted) by the liquid crystal layer 34, the selective reflection wavelength range of the liquid crystal layer 34 may be appropriately set, for example, by adjusting the helical pitch PT of the liquid crystal layer according to each of the liquid crystal diffraction elements.

The half-width of the selective reflection wavelength range of the liquid crystal layer 34 is adjusted depending on the application of the image display apparatus 10 and is, for example, 10 to 500 nm and preferably 20 to 300 nm and more preferably 30 to 100 nm.

### <<Liquid Crystal Alignment Pattern of Cholesteric Liquid Crystal Layer>>

Referring to FIGS. 2 and 3 again, the liquid crystal alignment pattern in the liquid crystal layer 34 will be described in detail.

In addition, in the present specification, in a case where the liquid crystal compound 40 is a rod-like liquid crystal compound, the optical axis 40A of the liquid crystal compound 40 refers to a molecular major axis of the rod-like liquid crystal compound. On the other hand, in a case where the liquid crystal compound 40 is a disk-like liquid crystal compound, the optical axis 40A of the liquid crystal compound 40 refers to an axis parallel to the normal direction (vertical direction) with respect to a disc plane of the disk-like liquid crystal compound.

In the present specification, the optical axis 40A derived from the liquid crystal compound 40 will also be referred to as “the optical axis 40A of the liquid crystal compound 40” or “the optical axis 40A”.

FIG. 3 is a plan view conceptually showing an example of the configuration of the liquid crystal layer 34.

The plan view is a view in a case where the polarization diffraction element 18 is seen from the top in FIG. 2, that is, a view in a case where the polarization diffraction element 18 is seen from a thickness direction (laminating direction of the respective layers (films)).

In addition, in FIG. 3, in order to clarify the configuration of the polarization diffraction element 18 according to the embodiment of the present invention, only the liquid crystal compound 40 on the surface of the alignment film 32 is shown.

As shown in FIG. 3, in the X-Y plane of the liquid crystal layer 34, the liquid crystal compounds 40 are arranged along a plurality of arrangement axes D parallel to the X-Y plane according to the alignment pattern formed on the alignment film 32 as the lower layer. On each of the arrangement axes D, the orientation of the optical axis 40A of the liquid crystal compound 40 changes while continuously rotating in the one direction along the arrangement axis D. Here, for the convenience of description, it is assumed that the arrangement axis D is directed to the X direction.

“The orientation of the optical axis 40A of the liquid crystal compound 40 changes while continuously rotating in the one direction along the arrangement axis D” represents that angles between the optical axes 40A of the liquid crystal compounds 40 and the arrangement axes D vary depending on positions in the arrangement axis D direction and gradually change from θ to θ+180° or θ−180° along the arrangement axis D. That is, in each of the plurality of liquid crystal compounds 40 arranged along the arrangement axis D, as shown in FIG. 3, the optical axis 40A changes along the arrangement axis D while rotating on a given angle basis.

A difference between the angles of the optical axes 40A of the liquid crystal compounds 40 adjacent to each other in the arrangement axis D direction is preferably 45° or less, more preferably 15° or less, and still more preferably less than 15°.

In the liquid crystal layer 34, in the liquid crystal alignment pattern of the liquid crystal compound 40, the length (distance) over which the optical axis 40A of the liquid crystal compound 40 rotates by 180° in the arrangement axis D direction in which the optical axis 40A changes while continuously rotating in a plane is the length Λ of the single period in the liquid crystal alignment pattern.

That is, a distance between centers of two liquid crystal compounds 40 in the arrangement axis D direction (arrow X direction) is the length Λ of the single period, the two liquid crystal compounds having the same angle in the arrangement axis D direction. Specifically, as shown in FIG. 3, a distance between centers in the arrangement axis D direction of two liquid crystal compounds 40 in which the arrangement axis D direction and the direction of the optical axis 40A match each other is the length Λ of the single period. In the following description, the length Λ of the single period will also be referred to as “single period Λ”.

In the liquid crystal alignment pattern of the liquid crystal layer 34, the single period Λ is repeated in the arrangement axis D direction, that is, in the one direction in which the orientation of the optical axis 40A changes while continuously rotating. In addition, the liquid crystal layer 34 has the region in which the single period Λ decreases in the direction away from the image projection element 12.

A difference between the angles of the optical axes 40A of the liquid crystal compounds 40 adjacent to each other in the arrangement axis D direction is preferably 45° or less, more preferably 15° or less, and still more preferably less than 15°.

On the other hand, in the liquid crystal compound 40 forming the liquid crystal layer 34, the orientations of the optical axes 40A are the same in the direction (in FIG. 3, the Y direction) perpendicular to the arrangement axis D direction, that is, the Y direction perpendicular to the one direction in which the optical axis 40A continuously rotates.

In other words, in the liquid crystal compound 40 forming the liquid crystal layer 34, angles between the optical axes 40A of the liquid crystal compounds 40 and the arrangement axis D (X direction) are the same in the Y direction.

FIG. 4 conceptually shows an image obtained by observing a cross section of the liquid crystal layer 34 shown in FIG. 2 in an X-Z direction with a scanning electron microscope (SEM: Scanning electron microscope). As shown in the drawing, in a case where the cross section of the liquid crystal layer 34 in the X-Z direction is observed with the SEM, an arrangement direction in which bright portions 42 and dark portions 44 are alternately arranged, a stripe pattern tilted at a predetermined angle with respect to the main surface (X-Y plane) is observed.

Basically, an interval of the bright portions 42 and the dark portions 44, that is, a surface pitch P depends on the helical pitch PT of the cholesteric liquid crystal layer.

Accordingly, the wavelength range of light that is selectively reflected by the cholesteric liquid crystal layer correlates to the interval of the bright portions 42 and the dark portions 44, that is, the surface pitch P. That is, as the surface pitch P increases, the helical pitch PT increases. Therefore, the wavelength range of light that is selectively reflected by the cholesteric liquid crystal layer increases. Conversely, as the surface pitch P decreases, the helical pitch PT decreases. Therefore, the wavelength range of light that is selectively reflected by the cholesteric liquid crystal layer decreases.

Here, in the cholesteric liquid crystal layer, basically, a structure in which the bright portion 42 and the dark portion 44 are repeated twice corresponds to the helical pitch PT. Accordingly, in the cross section observed with a SEM, an interval between the bright portions 42 adjacent to each other or between the dark portions 44 adjacent to each other in a normal direction (vertical direction) of lines formed by the bright portions 42 or the dark portions 44 corresponds to a ½ pitch of the surface pitch P.

That is, the surface pitch P may be measured by setting the interval between the bright portions 42 or between the dark portions 44 in the normal direction with respect to the lines as a ½ pitch.

In the liquid crystal layer 34 having the liquid crystal alignment pattern as in the example shown in the drawing, as described above, the bright portions 42 and the dark portions 44 are tilted at a predetermined angle with respect to the main surface. Therefore, in the following description, the surface pitch P of the liquid crystal layer 34 having the liquid crystal alignment pattern will also be referred to as the tilted surface pitch P.

Hereinafter, an action of diffraction of the liquid crystal layer 34 will be described.

The cholesteric liquid crystal layer obtained by immobilizing a cholesteric liquid crystalline phase typically reflects incident light (circularly polarized light) by specular reflection.

On the other hand, the liquid crystal layer 34 having the above-described liquid crystal alignment pattern reflects incidence light in a direction having an angle in the arrow X direction with respect to specular reflection. For example, in the liquid crystal layer 34, light incident from the normal direction is reflected in a state where it is tilted as indicated by the arrow X with respect to the normal direction instead of being reflected in the normal direction. That is, the light incident from the normal direction refers to light incident from the front side, that is, light that is vertically incident into a main surface. The main surface refers to the maximum surface of a sheet-shaped material.

In the liquid crystal layer 34, by appropriately setting the arrangement axis D direction as the one direction in which the optical axis 40A rotates, the reflection direction (diffraction angle) of light can be adjusted.

In addition, in a case where circularly polarized light having the same wavelength and the same turning direction is reflected, by reversing the rotation direction of the optical axis 40A of the liquid crystal compound 40 toward the arrangement axis D direction, a reflection direction of the circularly polarized light can be reversed.

For example, in FIGS. 2 and 3, the rotation direction of the optical axis 40A toward the arrangement axis D direction is clockwise, and one circularly polarized light is reflected in a state where it is tilted in the arrangement axis D direction. By setting the rotation direction of the optical axis 40A to be counterclockwise, the circularly polarized light is reflected in a state where it is tilted in a direction opposite to the arrangement axis D direction.

Further, in the liquid crystal layer having the same liquid crystal alignment pattern, the reflection direction is reversed by adjusting the helical turning direction of the liquid crystal compound 40, that is, the turning direction of circularly polarized light to be reflected.

For example, in a case where the helical turning direction of the liquid crystal layer is right-twisted, the liquid crystal layer selectively reflects right circularly polarized light, and has the liquid crystal alignment pattern in which the optical axis 40A rotates clockwise in the arrangement axis D direction. As a result, the right circularly polarized light is reflected in a state where it is tilted in the arrangement axis D direction.

In addition, for example, in a case where the helical turning direction of the liquid crystal layer is left-twisted, the liquid crystal layer selectively reflects left circularly polarized light, and has the liquid crystal alignment pattern in which the optical axis 40A rotates clockwise in the arrangement axis D direction. As a result, the left circularly polarized light is reflected in a state where it is tilted in a direction opposite to the arrangement axis D direction.

As described above, the polarization diffraction element 18 is suitably used as an element that reflects light (image) projected by an image projection element in AR glasses or the like. Accordingly, in the polarization diffraction element 18, the arrangement axis D direction of the liquid crystal layer 34 and the rotation direction of the optical axis 40A in the liquid crystal alignment pattern are set such that incident light is appropriately directed to the observation position by the user U.

Here, as shown in FIG. 1, the incidence angle of the virtual image A incident from the image projection element 12 into the polarization diffraction element 18 (liquid crystal layer 34) varies depending on positions of the polarization diffraction element 18. In the present specification, the incidence angle of the virtual image A refers to an angle between the normal line (line perpendicular to the main surface) of the polarization diffraction element 18 and the virtual image A incident into the polarization diffraction element 18. For example, in an upper end part of the polarization diffraction element 18 in the drawing, the incidence angle of the virtual image A is more than that of in a lower end part thereof.

Accordingly, in order to appropriately emit the virtual image A reflected (diffracted) by the polarization diffraction element 18 to the observation position by the user U, the diffraction angle of the virtual image A in the lower end part of the polarization diffraction element 18 in the drawing needs to be more than that of the upper end part thereof.

On the other hand, as conceptually shown in FIG. 2, the polarization diffraction element 18 in the image display apparatus 10 according to the embodiment of the present invention has the region in which the single period Λ in the liquid crystal alignment pattern of the liquid crystal layer 34 decreases in the direction away from the image projection element 12.

Specifically, assuming that the image projection element 12 is positioned on the left side in FIG. 2, the incidence angle of the virtual image A increases in a direction from the left side to the right side in the drawing that is the direction away from the image projection element 12. Accordingly, the single period Λ in the liquid crystal alignment pattern of the liquid crystal layer 34 gradually decreases in a direction from the left side to the right side in the drawing that is the direction away from the image projection element 12, for example, a single period Λ_{A0}, a single period Λ_{A1}, a single period Λ_{A2}, and . . . .

The liquid crystal layer having the liquid crystal alignment pattern has a region where, as the single period Λ decreases, the diffraction angle of reflected light with respect to the incidence light increases. That is, as the single period Λ decreases, incidence light can be largely diffracted to be reflected in a direction that is largely different from specular reflection.

In the image display apparatus 10 according to the embodiment of the present invention, the region where the single period Λ decreases in the direction (positive direction of the arrow X) away from the image projection element 12 is provided in the liquid crystal alignment pattern. As a result, the reflection angle with respect to incidence light increases, and the virtual image A projected from the image projection element 12 can be appropriately emitted to the observation position by the user U in the entire area of the polarization diffraction element 18 irrespective of the distance from the image projection element 12, that is, the incidence angle.

In addition, as conceptually shown in FIG. 2, the polarization diffraction element 18 in the image display apparatus 10 according to the embodiment of the present invention has regions where the pitch of the helical structure (helical pitch PT) in the liquid crystal layer 34 varies in a plane.

Specifically, in the liquid crystal layer 34 shown in FIG. 2, a helical pitch PT₂ in the right side region of the drawing is longer than a helical pitch PT₀ in the left side region of the drawing, and a helical pitch PT₁ (not shown) in the intermediate region in the left-right direction of the drawing is longer than the helical pitch PT₀ and is shorter than the helical pitch PT₂. That is, the liquid crystal layer 34 has a configuration where the helical pitch PT increases in the direction (positive direction of the arrow X) away from the image projection element 12.

The helical pitch PT is the distance over which the liquid crystal compound rotates helically once (360° rotation). In FIG. 2, schematically, distances over which the liquid crystal compound rotates half a rotation (180° rotation) are represented by PT₀ and PT₂.

In addition, in the present specification, “the liquid crystal layer having the regions where the helical pitch PT varies in a plane” represents that two or more regions where average values of single pitches of the helical structure in the thickness direction are different from each other are present in a plane of the liquid crystal layer.

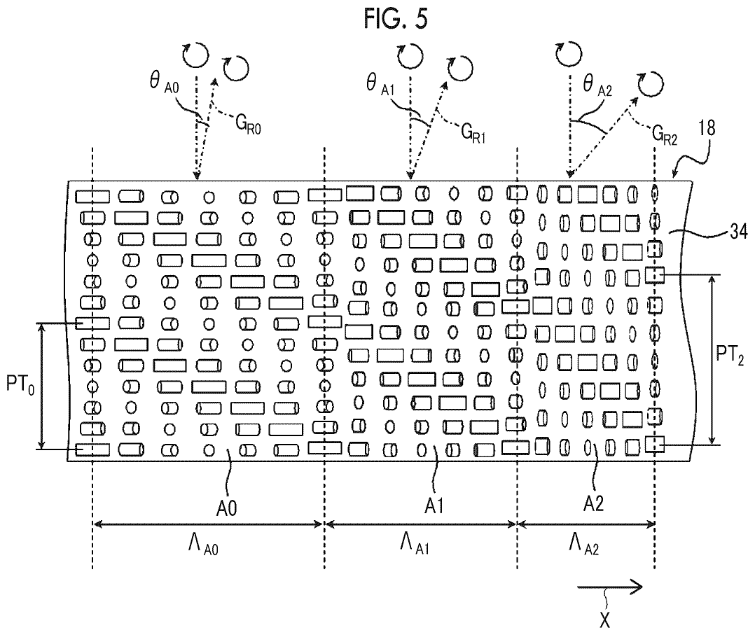

Hereinafter, the optical element according to the embodiment of the present invention will be described in more detail by describing the action of the polarization diffraction element 18 according to the embodiment of the present invention with reference to FIG. 5.

FIG. 5 is a conceptual diagram showing the action of the liquid crystal layer 34 in the polarization diffraction element 18 shown in FIG. 2. In FIG. 5, in order to clearly show the actions of the liquid crystal layer 34 and the polarization diffraction element 18, it is assumed that light is incident from the normal direction (front side) into the polarization diffraction element 18.

In addition, the liquid crystal layer 34 selectively reflects right circularly polarized light G_{R} of green light and allows transmission of the other light.

In addition, in the portion shown in FIG. 5, the liquid crystal layer 34 includes three regions A0, A1, A2 in order from the left side in FIG. 5, and the respective regions have different lengths of helical pitches PT and different lengths Λ of single periods. Specifically, the helical pitch PT increases in order of the regions A0, A1, and A2, and the length Λ of the single period decreases in order of the regions A0, A1, and A2.

In FIG. 5, a part of the liquid crystal layer 34 is shown, and the liquid crystal layer 34 may have four or more regions where the lengths of the helical pitches and the lengths Λ of the single periods are different.

In the polarization diffraction element 18, in a case where right circularly polarized light G_{R1} of green light is incident into an in-plane region A1 of the liquid crystal layer 34, as described above, the light is reflected in a direction that is tilted by a predetermined angle in the arrow X direction, that is, in the one direction in which the orientation of the optical axis of the liquid crystal compound changes while continuously rotating with respect to the incidence direction. Likewise, in a case where right circularly polarized light G_{R2} of green light is incident into an in-plane region A2 of the liquid crystal layer 34, the light is reflected in a direction that is tilted by a predetermined angle in the arrow X direction with respect to the incidence direction. Likewise, in a case where the right circularly polarized light G_{R2} of green light is incident into an in-plane region A0 of the liquid crystal layer 34, the light is reflected in a direction that is tilted by a predetermined angle in the arrow X direction with respect to the incidence direction.

Here, as described above, the liquid crystal layer 34 has the liquid crystal alignment pattern in which the optical axis 40A derived from the liquid crystal compound 40 changes while continuously rotating clockwise in the arrow X direction.

In addition, as shown in FIG. 5, since the single period Λ_{A2} of the liquid crystal alignment pattern of the region A2 is shorter than the single period Λ_{A1} of the liquid crystal alignment pattern of the region A1, a reflection angle θ_{A2} of reflected light of the region A2 is more than a reflection angle θ_{A1} of reflected light of the region A1 with respect to the incidence light. Likewise, since the single period Λ_{A0} of the liquid crystal alignment pattern of the region A0 is longer than the single period Λ_{A1} of the liquid crystal alignment pattern of the region A1, a reflection angle θ_{A0} of reflected light of the region A0 is less than a reflection angle θ_{A1} of reflected light of the region A1 with respect to the incidence light.

Here, in the reflection of light from the cholesteric liquid crystal layer, a so-called blue shift (short-wavelength shift) in which the wavelength of light to be selectively reflected shifts to a short wavelength side occurs depending on angles of incidence light. Therefore, in the cholesteric liquid crystal layer that has a liquid crystal alignment pattern in which an orientation of an optical axis derived from a liquid crystal compound changes while continuously rotating in at least one in-plane direction, there is a problem in that the amount of reflected light decreases due to influence of blue shift (short-wavelength shift) as the reflection angle increases. Therefore, in a case where the patterned cholesteric liquid crystal layer has regions having different lengths of the single periods over which the orientation of the optical axis of the liquid crystal compound rotates by 180° in a plane, the reflection angle varies depending on light incidence positions. Therefore, there is a difference in the amount of reflected light depending on in-plane incidence positions. For example, the amount of reflected light in the region A1 is less than the amount of reflected light in the region A0, and the amount of reflected light in the region A2 is less than the amount of reflected light in the region A1. That is, it was found that there is a problem in that a region where the brightness of light reflected is low depending on incidence positions is present in a plane, and brightness unevenness occurs in a plane of the observation image by the user U.

On the other hand, the liquid crystal layer 34 in the image display apparatus according to the embodiment of the present invention has regions where the helical pitch PT varies in a plane.

In the example shown in FIG. 5, in the liquid crystal layer 34, a length PT₂ of the pitch of the helical structure in the region A2 is longer than a length PT₁ of the pitch of the helical structure in the region A1, and a length PT₀ of the pitch of the helical structure in the region A0 is shorter than the length PT₁ of the pitch of the helical structure in the region A1.

As a result, the influence of blue shift in which the wavelength of light to be selectively reflected shifts to a short wavelength side can be reduced, and a decrease in the amount of reflected light in the region where the reflection angle of reflected light is large can be suppressed. Specifically, by increasing the helical pitch PT such that a selective reflection wavelength during blue shift is a wavelength of incident light, a reflection efficiency at the wavelength of the incident light can be increased. Accordingly, the formation of a region where the brightness of light reflected is low depending on in-plane incidence positions can be suppressed.

In the example shown in FIG. 5, the helical pitch PT₁ in the region A1 where the reflection angle θ_{A1} of reflected light is more than the reflection angle θ_{A0} of reflected light of the region A0, that is, the single period Λ_{A1} is shorter than the single period Λ_{A0} of the region A0 is longer than the helical pitch PT₀ of the region A0. In addition, the helical pitch PT₂ in the region A2 where the reflection angle θ_{A2} of reflected light is the largest, that is, the single period Λ_{A2} is the shortest is longer than the helical pitch PT₀ of the region A0 and the helical pitch PT₁ of the region A1. As a result, a decrease in the amounts of light reflected from the region A1 and the region A2 is suppressed. Thus, the amount of reflected light is uniform irrespective of incidence positions of incidence light in a plane of the polarization diffraction element, and in-plane brightness unevenness can be suppressed.

This way, in the polarization diffraction element 18 of the image display apparatus 10 according to the embodiment of the present invention, in the in-plane region where the reflection angle from the liquid crystal layer 34 is large, incidence light is reflected from the region where the helical pitch PT is long. On the other hand, in the in-plane region where the reflection angle from the liquid crystal layer 34 is small, incidence light is reflected from the region where the helical pitch PT is short.

That is, in the polarization diffraction element 18, by setting the helical pitch PT in a plane to different lengths depending on the size of the reflection angle from the liquid crystal layer 34, a decrease in the amount of reflected light with respect to incidence light can be suppressed.

Therefore, in the image display apparatus 10 according to the embodiment of the present invention, the reflection angle dependence of the amount of reflected light in a plane can be reduced, and in-plane brightness unevenness of an observation image can be suppressed.

As described above, the angle of reflected light in a plane of the liquid crystal layer 34 increases as the single period Λ of the liquid crystal alignment pattern decreases. Accordingly, by setting the helical pitch PT having a length corresponding to the single period Λ of the liquid crystal alignment pattern as a target, the brightness of light reflected from different in-plane regions at different angles can be suitably increased.

Therefore, in the liquid crystal layer 34 according to the embodiment of the present invention, in regions having different lengths of single periods Λ of liquid crystal alignment patterns, it is preferable that a permutation of the lengths of the single periods Λ and a permutation of the lengths of the helical pitches PT are different from each other. In other words, it is preferable that the liquid crystal layer 34 has the region in which the single period Λ decreases and the helical pitch PT increases in the in-plane direction away from the image projection element.

However, the image display apparatus according to the embodiment of the present invention is not limited to this configuration. In regions having different lengths of single periods Λ of liquid crystal alignment patterns, a permutation of the lengths of the single periods Λ and a permutation of the lengths of the helical pitches PT may be the same as each other.

In the liquid crystal diffraction element, it is preferable that the cholesteric liquid crystal layer has a radial pattern that is provided in a radial shape from the inner side toward the outer side in the one direction in which the optical axis 40A derived from the liquid crystal compound 40 in the liquid crystal alignment pattern changes while continuously rotating.

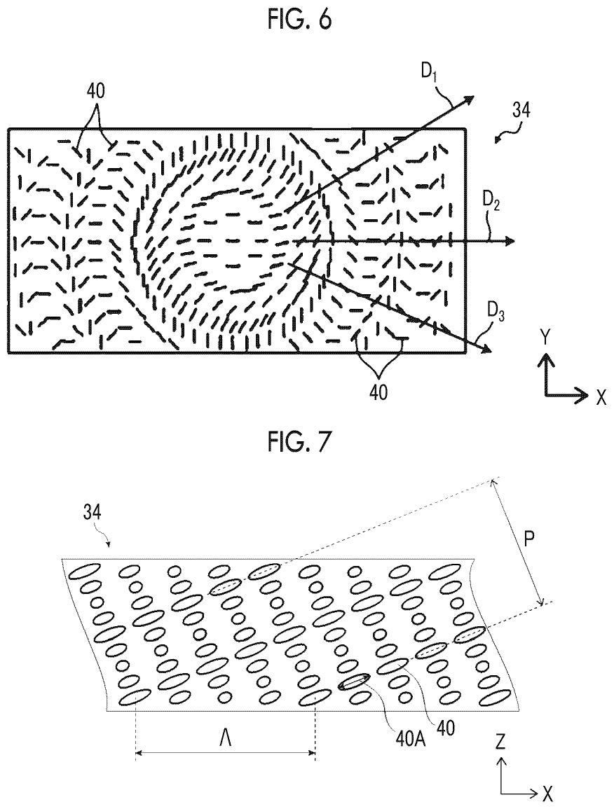

FIG. 6 is a plan view showing the cholesteric liquid crystal layer where the liquid crystal alignment pattern is the radial pattern. FIG. 6 shows only the liquid crystal compound 40 of the surface of the alignment film as in FIG. 3. However, the cholesteric liquid crystal layer 34 has the helical structure in which the liquid crystal compound 40 on the surface of the alignment film is helically twisted and laminated as described above.

In the liquid crystal layer 34 shown in FIG. 6, the optical axis (not shown) of the liquid crystal compound 40 is a longitudinal direction of the liquid crystal compound 40. In the liquid crystal layer 34, the orientation of the optical axis of the liquid crystal compound 40 changes while continuously rotating in a large number of directions from the center of the liquid crystal layer 34 to the outer side, for example, a direction indicated by an arrow D₁, a direction indicated by an arrow D₂, a direction indicated by an arrow D₃, or . . . . That is, the liquid crystal layer 34 has the radial shape from the inner side to the outer side in the arrow D direction.

In addition, in a preferable aspect, in the example shown in FIG. 6, the direction of the optical axis changes in a radial shape from the center of the liquid crystal layer 34 while rotating in the same direction. In the aspect shown in FIG. 6, counterclockwise alignment is shown. Rotation directions of the optical axes in the respective arrow directions D₁, D₂, D₃, and . . . in FIG. 6 are counterclockwise from the center to the outer side.

This way, in the liquid crystal layer 34 having the radial liquid crystal alignment pattern, incidence light can be allowed as diverging light or converging light depending on the rotation direction of the optical axis of the liquid crystal compound 40 and the direction of circularly polarized light to be reflected.

That is, by setting the liquid crystal alignment pattern of the cholesteric liquid crystal layer in a radial shape, the liquid crystal diffraction element exhibits, for example, a function as a concave mirror or a convex mirror.

Here, in a case where the liquid crystal alignment pattern of the cholesteric liquid crystal layer is radial such that the liquid crystal diffraction element functions as a concave mirror, it is preferable that the single period Λ over which the optical axis rotates by 180° in the liquid crystal alignment pattern gradually decreases from the center of the cholesteric liquid crystal layer toward the outer direction in the one direction in which the optical axis continuously rotates.

As described above, the reflection angle of light with respect to an incidence direction increases as the single period Λ in the liquid crystal alignment pattern decreases. Accordingly, the single period Λ in the liquid crystal alignment pattern gradually decreases from the center of the cholesteric liquid crystal layer toward the outer direction in the one direction in which the optical axis continuously rotates. As a result, light can be further collected, and the performance as a concave mirror can be improved.

Here, as described above, in the cholesteric liquid crystal layer, in a region where the length Λ of the single period in the liquid crystal alignment pattern is short and the reflection angle is large, the amount of reflected light is small. That is, in the example shown in FIG. 6, in an outer region where the reflection angle is large, the amount of reflected light is small.

On the other hand, in the liquid crystal diffraction element, the cholesteric liquid crystal layer has regions having different pitches of helical structures. In the example shown in FIG. 6, in the cholesteric liquid crystal layer, the pitch of the helical structure gradually increases from the center toward the outside in the one direction in which the optical axis continuously rotates. As a result, a decrease in the amount of reflected light in an outer region of the cholesteric liquid crystal layer can be suppressed.

In a case where the liquid crystal diffraction element functions as a convex mirror, it is preferable that the continuous rotation direction of the optical axis in the liquid crystal alignment pattern is in a direction opposite to that of the case of the above-described concave mirror from the center of the cholesteric liquid crystal layer.

In addition, by gradually decreasing the single period Λ over which the optical axis rotates by 180° from the center of the cholesteric liquid crystal layer toward the outer direction in the one direction in which the optical axis continuously rotates, light incident into the cholesteric liquid crystal layer can be further dispersed, and the performance as a convex mirror can be improved.

Further, in the cholesteric liquid crystal layer, the pitch of the helical structure gradually increases from the center toward the outside in the one direction in which the optical axis continuously rotates. As a result, a decrease in the amount of reflected light in an outer region of the cholesteric liquid crystal layer can be suppressed.

In a case where the liquid crystal diffraction element functions as a convex mirror, it is preferable that a direction of circularly polarized light to be reflected (sense of a helical structure) from the cholesteric liquid crystal layer is reversed to be opposite to that in the case of a concave mirror, that is, the helical turning direction of the cholesteric liquid crystal layer is reversed.

Even in this case, by gradually decreasing the single period Λ over which the optical axis rotates by 180° from the center of the cholesteric liquid crystal layer toward the outer direction in the one direction in which the optical axis continuously rotates, light reflected from the cholesteric liquid crystal layer can be further dispersed, and the performance as a convex mirror can be improved.

In a state where the helical turning direction of the cholesteric liquid crystal layer is reversed, the continuous rotation direction of the optical axis in the liquid crystal alignment pattern is reversed from the center of the cholesteric liquid crystal layer. As a result, the liquid crystal diffraction element can be made to function as a concave mirror.

Depending on the uses of the liquid crystal diffraction element, conversely, the single period Λ in the concentric circular liquid crystal alignment pattern may gradually increase from the center of the cholesteric liquid crystal layer toward the outer direction in the one direction in which the optical axis continuously rotates.

Further, depending on the uses of the liquid crystal diffraction element such as a case where it is desired to provide a light amount distribution in reflected light, a configuration in which regions having partially different lengths of the single periods Λ in the one direction in which the optical axis continuously rotates are provided can also be used instead of the configuration in which the single period Λ gradually changes in the one direction in which the optical axis continuously rotates.

Regarding an exposure method, an exposure device, and the like of the alignment film for aligning the above-described cholesteric liquid crystal layer, the exposure method and the exposure device described above can be used.

The more detailed configuration, material, and preparation method of the cholesteric liquid crystal layer and the exposure method and the like of the alignment film for aligning the cholesteric liquid crystal layer are described in WO2019/189852A.

In the liquid crystal layer in the image display apparatus according to the embodiment of the present invention, the length of the single period Λ of the liquid crystal alignment pattern and the length of the pitch of the helical structure (helical pitch PT) may be appropriately set.

Hereinafter, the single period Λ of the liquid crystal alignment pattern in the liquid crystal layer and the helical pitch PT in the liquid crystal layer will be described in more detail.

The single period Λ of the liquid crystal alignment pattern in the liquid crystal layer 34 is appropriately set depending on the distance from the image projection element 12. The distance from the image projection element 12 can be determined based on the distance from a position where the image projection element 12 projects the virtual image A to a plane of the polarization diffraction element 18 in an in-plane direction.

That is, in a region having a small incidence angle that is close to the image projection element 12, assuming that the single period Λ of the liquid crystal alignment pattern is the single period Λ_{A0}, the virtual image A is diffracted and reflected.

On the other hand, in a region having a larger incidence angle that is spaced from the image projection element 12, assuming that the single period Λ of the liquid crystal alignment pattern is the single period Λ_{A1} shorter than the single period Λ_{A0}, the virtual image A is reflected at a larger diffraction angle.

In a region having a much larger incidence angle that is more spaced from the image projection element 12, assuming that the single period Λ of the liquid crystal alignment pattern is the single period Λ_{A2} shorter than the single period Λ_{A1}, the virtual image A is reflected at a much larger diffraction angle.

By selecting the single period Λ (Λ_{A0}, Λ_{A1}, Λ_{A2}) of the liquid crystal alignment pattern depending on the distance from the image projection element 12 in the polarization diffraction element 18, the virtual image A can be appropriately emitted to the observation position in the entire region of the polarization diffraction element 18 irrespective of the distance from the image projection element 12 and the incidence angle.

The degree to which the single period Λ of the liquid crystal alignment pattern of the liquid crystal layer 34 decreases in the direction away from the image projection element 12 is not limited, and the single period Λ corresponding to the position of the liquid crystal layer 34 may be appropriately set depending on the positional relationship between the image projection element 12 and the polarization diffraction element 18, the wavelength of light as the virtual image A, the observation position of the virtual image A by the user U, and the like such that the virtual image A can be emitted to the observation position by the user U in the entire incidence region of the virtual image A in the polarization diffraction element 18.

In the image display apparatus 10 according to the embodiment of the present invention, the single period Λ of the liquid crystal alignment pattern of the liquid crystal layer 34 may decrease continuously or stepwise in the direction away from the image projection element 12, or a region where the single period Λ decreases continuously and a region where the single period Λ decreases stepwise may be mixed. In addition, the single period Λ of the liquid crystal alignment pattern of the liquid crystal layer 34 may decrease intermittently.

In addition, in the entire area of the liquid crystal layer 34 in the arrangement axis D direction, for example, the single period Λ of the liquid crystal alignment pattern may decrease in the direction away from the image projection element 12. Alternatively, in a region of the liquid crystal layer 34 other than a part on one end part side in the arrangement axis D direction, the single period Λ of the liquid crystal alignment pattern may decrease in the direction away from the image projection element 12. Alternatively, in a region of the liquid crystal layer 34 other than a part on both end sides in the arrangement axis D direction, the single period Λ of the liquid crystal alignment pattern may decrease in the direction away from the image projection element 12.

That is, in the image display apparatus 10 according to the embodiment of the present invention, as long as the liquid crystal layer 34 can appropriately reflect the virtual image A incident from the image projection element 12 to the observation position by the user U, the single period Λ of the liquid crystal alignment pattern may decrease in the direction away from the image projection element 12 in any region in the arrangement axis D direction.

In the image display apparatus 10 according to the embodiment of the present invention, the single period Λ of the liquid crystal layer 34 is not particularly limited and may be appropriately set such that the virtual image A incident into the polarization diffraction element 18 (liquid crystal layer 34) can be appropriately reflected to the observation position by the user U depending on the wavelength λ of incident light.

It is preferable that the liquid crystal layer 34 has a region where the single period Λ is 20 μm or less, it is more preferable that the liquid crystal layer 34 has a region where the single period Λ is 10 μm or less, and it is still more preferable that the liquid crystal layer 34 has a region where the single period Λ is less than 1 μm. In addition, it is still more preferable that the liquid crystal layer 34 has two or more regions where the single period Λ is less than 1 μm.

The lower limit value of the single period Λ of the liquid crystal layer 34 is not particularly limited, and is preferably 0.1 μm or more in consideration of the accuracy and the like of the liquid crystal alignment pattern.

The helical pitch PT of the cholesteric liquid crystal layer 34 is appropriately set together with the average refractive index n and the like of the cholesteric liquid crystalline phase forming the liquid crystal layer 34 to obtain a selective reflection wavelength close to the wavelength of incidence light where the incidence light can be reflected in the polarization diffraction element 18. In the range of the length of the pitch of the helical structure where the incidence light can be reflected and diffracted, different helical pitches PT can be selected depending on in-plane regions.

For example, in a case where the target of the polarization diffraction element 18 is green light, in a range of the helical pitch PT that overlaps a wavelength range where the selective reflection wavelength of each of the regions of the liquid crystal layer 34 is 495 to 570 nm, the helical pitch PT for each of the regions may be selected such that the helical pitch PT gradually increases from a region of the liquid crystal layer 34 close to the image projection element 12 as in the helical pitch PT₀, the helical pitch PT₁, the helical pitch PT₂, and . . . .

In addition, in a case where the image display apparatus includes a plurality of polarization diffraction elements having different wavelength ranges (colors) as the target of reflection and diffraction, In one polarization diffraction element, it is preferable that the helical pitch PT in each of the regions is selected to minimize a range that overlaps a wavelength range of light other than target light.

The helical pitch PT in the region of the cholesteric liquid crystal layer, for example, the wavelength λ of incidence light reflected in the region, the average refractive index n of the cholesteric liquid crystalline phase forming the liquid crystal layer 34, and the single period Λ of the liquid crystal alignment pattern preferably satisfy Expression (1), more preferably satisfy Expression (2), and still more preferably satisfy Expression (3).

$$0.5 \times PT / cos ( PT / 2 / Λ ) \leq λ / n \leq 2 \times PT / cos ( PT / 2 / Λ ) \qquad ( 1 )$$

$$0.7 \times PT / cos ( PT / 2 / Λ ) \leq λ / n \leq 1.5 \times PT / cos ( PT / 2 / Λ ) \qquad ( 2 )$$

$$0.8 \times PT / cos ( PT / 2 / Λ ) \leq λ / n \leq 1.3 \times PT / cos ( PT / 2 / Λ ) \qquad ( 3 )$$

In a case where a direction in which regions having a constant helical pitch PT are arranged in the cholesteric liquid crystal layer is set as a change direction of the helical pitch PT, the change direction of the helical pitch PT may be the same as or different from the one direction in which the optical axis rotates. That is, the change direction of the helical pitch PT may intersect the one direction in which the optical axis rotates. Even in the configuration in which the change direction of the helical pitch PT intersects the in-plane direction in which the optical axis rotates, the helical pitch changes (increases) from one side toward another side in the one direction in which the optical axis rotates.

As described above, the helical pitch PT of the cholesteric liquid crystal layer can be obtained by measuring an interval (surface pitch P) of lines formed by bright portions or dark portions in the normal direction from a stripe pattern that appears in an observation image of a SEM of a cross section (X-Z plane shown in FIG. 4) including the direction in which the optical axis of the cholesteric liquid crystal layer changes and the thickness direction.

In the image display apparatus according to the embodiment of the present invention, the cholesteric liquid crystal layer in the polarization diffraction element is not limited to the aspects shown in FIGS. 2 to 5.

In the polarization diffraction element 18 shown in FIG. 2, on the X-Z plane of the liquid crystal layer 34, the optical axis 40A of the liquid crystal compound 40 is aligned to be parallel to the main surface (X-Y plane). However, the present invention is not limited to this configuration.

FIG. 7 conceptually shows another example of the cholesteric liquid crystal layer. For example, as conceptually shown in FIG. 7, a configuration in which, on the X-Z plane of the liquid crystal layer 34, the optical axes 40A of the liquid crystal compound 40 are aligned to be tilted with respect to the main surface (X-Y plane) may be adopted.

In addition, the example shown in FIG. 7 shows the configuration in which, on the X-Z plane of the liquid crystal layer 34, the tilt angle of the liquid crystal compound 40 with respect to the main surface (X-Y plane) is uniform in the thickness direction (Z direction). However, the present invention is not limited to this configuration. In the liquid crystal layer 34, a region where the tilt angle of the liquid crystal compound 40 varies in the thickness direction may be provided.

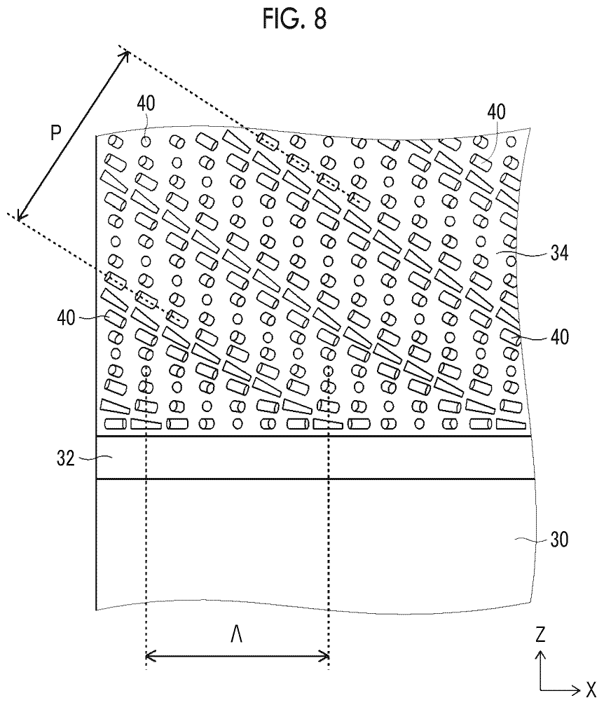

FIG. 8 conceptually shows another example of the cholesteric liquid crystal layer. For example, as shown in FIG. 8, the optical axis 40A of the liquid crystal compound 40 at an interface of the liquid crystal layer on the alignment film 32 side is parallel to the main surface (the pretilt angle is 0°), the tilt angle of the liquid crystal compound 40 increases in a direction away from the interface on the alignment film 32 side to the thickness direction, and the liquid crystal compound is aligned at a given tilt angle on another interface (air interface).

This way, the cholesteric liquid crystal layer may have a configuration in which the optical axis of the liquid crystal compound has a pretilt angle at one interface among the upper and lower interfaces or may have a pretilt angle at both of the interfaces. In addition, the pretilt angles at both of the interfaces may be different from each other.

The liquid crystal compound has the tilt angle (is tilted). As a result, in a case where light is diffracted, the effective birefringence index of the liquid crystal compound increases, and the diffraction efficiency can be improved.

The average angle (average tilt angle) between the optical axis 40A of the liquid crystal compound 40 and the main surface (X-Y plane) is preferably 5° to 80° and more preferably 10° to 50°. The average tilt angle can be measured by observing the X-Z plane of the liquid crystal layer 34 with a polarization microscope. In particular, it is preferable that, on the X-Z plane of the liquid crystal layer 34, the optical axis 40A of the liquid crystal compound 40 is aligned to be tilted with respect to the main surface (X-Y plane) in the same direction.

In a case where the cross-section of the cholesteric liquid crystal layer is observed with a polarization microscope, the tilt angle is a value obtained by measuring the angle between the optical axis 40A of the liquid crystal compound 40 and the main surface at any five or more positions and obtaining the average value thereof.

Light that is vertically incident into the liquid crystal layer 34 (diffraction element) travels obliquely in an oblique direction in the liquid crystal layer along with a bending force. In a case where light travels in the liquid crystal layer, diffraction loss is generated due to a deviation from conditions such as a diffraction period that are set to obtain a desired diffraction angle with respect to the vertically incident light.

In a case where the liquid crystal compound is tilted, an orientation in which a higher birefringence index is generated than that in an orientation in which light is diffracted as compared to a case where the liquid crystal compound is not tilted is present. In this direction, the effective extraordinary light refractive index increases, and thus the birefringence index as a difference between the extraordinary light refractive index and the ordinary light refractive index increases.

By setting the orientation of the tilt angle according to the desired diffraction orientation, a deviation from the original diffraction conditions in the orientation can be suppressed. As a result, it is presumed that, in a case where the liquid crystal compound having a tilt angle is used, a higher diffraction efficiency can be obtained.

In addition, it is preferable that the tilt angle is controlled by treating the interface of the liquid crystal layer 34.

By pretilting the alignment film on the support side interface, the tilt angle of the liquid crystal compound can be controlled. For example, by exposing the alignment film to ultraviolet light from the front and subsequently obliquely exposing the alignment film during the formation of the alignment film, the liquid crystal compound in the liquid crystal layer formed on the alignment film can be made to have a pretilt angle. In this case, the liquid crystal compound is pretilted in a direction in which the single axis side of the liquid crystal compound can be seen with respect to the second irradiation direction. Since the liquid crystal compound having an orientation in a direction perpendicular to the second irradiation direction is not pretilted, a region where the liquid crystal compound is pretilted and a region where the liquid crystal compound is not pretilted are present in a plane. This configuration is suitable for improving the diffraction efficiency because it contributes to the most improvement of birefringence in the desired direction in a case where light is diffracted in the direction.

Further, an additive for promoting the pretilt angle can also be added to the liquid crystal layer or to the alignment film. In this case, the additive can be used as a factor for further improving the diffraction efficiency.

This additive can also be used for controlling the pretilt angle on the air side interface.

Here, in a cross section of the liquid crystal layer 34 observed with a SEM, the bright portions and the dark portions derived from a cholesteric liquid crystalline phase are tilted with respect to the main surface.

In the liquid crystal layer, it is preferable that, in a case where an in-plane retardation Re is measured from a normal direction and a direction tilted with respect to a normal line, a direction in which the in-plane retardation Re is the minimum in any one of a slow axis plane or a fast axis plane is tilted from the normal direction. Specifically, it is preferable that an absolute value of the measured angle between the direction in which the in-plane retardation Re is the minimum and the normal line is 5° or more. In other words, it is preferable that the liquid crystal compound of the liquid crystal layer is tilted with respect to the main surface and the tilt direction substantially matches the bright portions and the dark portions of the liquid crystal layer. The normal direction is a direction perpendicular to the main surface.

By the liquid crystal layer having the above-described configuration, circularly polarized light can be diffracted with a higher diffraction efficiency than the liquid crystal layer in which the liquid crystal compound is parallel to the main surface.

In the configuration in which the liquid crystal compound of the liquid crystal layer is tilted with respect to the main surface and the tilt direction substantially matches the bright portions and the dark portions, bright portions and dark portions corresponding to a reflecting surface match the optical axis of the liquid crystal compound. Therefore, the action of the liquid crystal compound on light reflection (diffraction) increases, the diffraction efficiency can be improved. As a result, the amount of reflected light with respect to incidence light can be further improved.

In the fast axis plane or the slow axis plane of the liquid crystal layer, the absolute value of the tilt angle of the optical axis of the liquid crystal layer is preferably 5° or more, more preferably 150 or more, and still more preferably 20° or more.

It is preferable that the absolute value of the tilt angle of the optical axis is 15° or more from the viewpoint that the direction of the liquid crystal compound matches the bright portions and the dark portions more suitably such that the diffraction efficiency can be improved.

### <<Method of Forming Liquid Crystal Layer>>

The liquid crystal layer (cholesteric liquid crystal layer) 34 can be formed by immobilizing a cholesteric liquid crystalline phase in a layer shape, the liquid crystal phase obtained by aligning the liquid crystal compound 40 in a predetermined alignment state.

The structure in which a cholesteric liquid crystalline phase is immobilized may be a structure in which the alignment of the liquid crystal compound as a cholesteric liquid crystalline phase is maintained. Typically, it is preferable that the structure in which a predetermined liquid crystalline phase is immobilized is a structure which is obtained by making the polymerizable liquid crystal compound to be in a state where a cholesteric liquid crystalline phase is aligned, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which a cholesteric liquid crystalline phase is immobilized is not particularly limited as long as the optical characteristics of the cholesteric liquid crystalline phase are maintained, and the liquid crystal compound 40 in the liquid crystal layer does not necessarily exhibit liquid crystallinity. For example, the molecular weight of the polymerizable liquid crystal compound may be increased by a curing reaction such that the liquid crystallinity thereof is lost.

Examples of a material used for forming the liquid crystal layer include a liquid crystal composition including a liquid crystal compound. It is preferable that the liquid crystal compound is a polymerizable liquid crystal compound.

In addition, the liquid crystal composition used for forming the liquid crystal layer may further include a surfactant and a chiral agent.

### —Polymerizable Liquid Crystal Compound—

The polymerizable liquid crystal compound may be a rod-like liquid crystal compound or a disk-like liquid crystal compound.

Examples of the rod-like polymerizable liquid crystal compound include a rod-like nematic liquid crystal compound. As the rod-like nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a polymer liquid crystal compound can be used.

The polymerizable liquid crystal compound can be obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3.

Examples of the polymerizable liquid crystal compound include compounds described in Makromol. Chem. (1989), Vol. 190, p. 2255, Advanced Materials (1993), Vol. 5, p. 107, U.S. Pat. Nos. 4,683,327A, 5,622,648A, 5,770,107A, WO95/022586A, WO95/024455A, WO97/000600A, WO98/023580A, WO98/052905A, JP1989-272551A (JP-H1-272551A), JP1994-016616A (JP-H6-016616A), JP1995-110469A (JP-H7-110469A), JP1999-080081A (JP-H11-080081A), and JP2001-328973A. Two or more polymerizable liquid crystal compounds may be used in combination. In a case where two or more polymerizable liquid crystal compounds are used in combination, the alignment temperature can be decreased.

In addition, as a polymerizable liquid crystal compound other than the above-described examples, for example, a cyclic organopolysiloxane compound having a cholesteric phase described in JP1982-165480A (JP-S57-165480A) can be used. Further, as the above-described polymer liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

### —Disk-Like Liquid Crystal Compound—

As the disk-like liquid crystal compound, for example, compounds described in JP2007-108732A and JP2010-244038A can be preferably used.

In addition, the addition amount of the polymerizable liquid crystal compound in the liquid crystal composition is preferably 75% to 99.9% by mass, more preferably 80% to 99% by mass, and still more preferably 85% to 90% by mass with respect to the solid content mass (mass excluding a solvent) of the liquid crystal composition.

### —Surfactant—

The liquid crystal composition used for forming the liquid crystal layer may include a surfactant.

It is preferable that the surfactant is a compound that can function as an alignment control agent contributing to the stable or rapid alignment of a cholesteric liquid crystalline phase. Examples of the surfactant include a silicone-based surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-099248A, exemplary compounds described in paragraphs “0076” to “0078” and “0082” to “0085” of JP2002-129162A, and fluorine (meth)acrylate polymers described in paragraphs “0018” to “0043” of JP2007-272185A.

The surfactants may be used alone or in combination of two or more kinds.

As the fluorine-based surfactant, a compound described in paragraphs “0082” to “0090” of JP2014-119605A is preferable.

The addition amount of the surfactant in the liquid crystal composition is preferably 0.01% to 10% by mass, more preferably 0.01% to 5% by mass, and still more preferably 0.02% to 1% by mass with respect to the total mass of the liquid crystal compound.

### —Chiral Agent (Optically Active Compound)—

The chiral agent has a function of causing a helical structure of a cholesteric liquid crystalline phase to be formed. The chiral agent may be selected depending on the purpose because a helical twisted direction or a helical pitch (that is, a tilted surface pitch) derived from the compound varies.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes a chiral carbon atom. However, an axially chiral compound or a planar chiral compound not having a chiral carbon atom can also be used as the chiral agent. Examples of the axially chiral compound or the planar chiral compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a pattern having a desired reflection wavelength corresponding to a luminescence wavelength can be formed by irradiation of an actinic ray or the like through a photomask after coating and alignment, which is preferable. As the photoisomerization group, an isomerization portion of a photochromic compound, an azo group, an azoxy group, or a cinnamoyl group is preferable. Specific examples of the compound include compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably 0.01% to 200% by mole and more preferably 1% to 30% by mole with respect to the content molar amount of the liquid crystal compound.

### —Polymerization Initiator—

In a case where the liquid crystal composition includes a polymerizable compound, it is preferable that the liquid crystal composition includes a polymerization initiator. In an aspect where a polymerization reaction progresses with ultraviolet irradiation, it is preferable that the polymerization initiator is a photopolymerization initiator that can initiate a polymerization reaction with ultraviolet irradiation.

Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the photopolymerization initiator in the liquid crystal composition is preferably 0.1% to 20% by mass and more preferably 0.5% to 12% by mass with respect to the content of the liquid crystal compound.

### —Crosslinking Agent—

In order to improve the film hardness after curing and to improve durability, the liquid crystal composition may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris[3-(1-aziridinyl)propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof, and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. The crosslinking agents may be used alone or in combination of two or more kinds.

The content of the crosslinking agent is preferably 3% to 20% by mass and more preferably 5% to 15% by mass with respect to the solid content mass of the liquid crystal composition. In a case where the content of the crosslinking agent is in the range, an effect of improving a crosslinking density can be easily obtained and the stability of a liquid crystal phase is further improved.

### —Other Additives—

Optionally, a polymerization inhibitor, an antioxidant, an ultraviolet absorber, a light stabilizer, a coloring material, metal oxide fine particles, or the like can be added to the liquid crystal composition in a range where optical performance and the like do not deteriorate.

In a case where the liquid crystal layer is formed, it is preferable that the liquid crystal composition is used as liquid.

The liquid crystal composition may include a solvent. The solvent is not particularly limited and can be appropriately selected depending on the purpose. An organic solvent is preferable.

The organic solvent is not particularly limited and can be appropriately selected depending on the purpose. Examples of the organic solvent include a ketone, an alkyl halide, an amide, a sulfoxide, a heterocyclic compound, a hydrocarbon, an ester, and an ether. The organic solvents may be used alone or in combination of two or more kinds. Among these, a ketone is preferable in consideration of an environmental burden.

In a case where the liquid crystal layer 34 is formed, it is preferable that the liquid crystal layer 34 is formed by applying the liquid crystal composition to a surface where the liquid crystal layer 34 is to be formed, aligning the liquid crystal compound 40 to a state of a desired liquid crystalline phase, and curing the liquid crystal compound 40.

That is, in a case where the cholesteric liquid crystal layer is formed on the alignment film 32, it is preferable that the liquid crystal layer 34 obtained by immobilizing a cholesteric liquid crystalline phase is formed by applying the liquid crystal composition to the alignment film 32, aligning the liquid crystal compound 40 to a state of a cholesteric liquid crystalline phase, and curing the liquid crystal compound 40.

As the alignment film 32 to which the liquid crystal composition is applied, the alignment film that has the alignment pattern having the region where the alignment state periodically changes in the above-described one direction and the length of the single period gradually decreases in the one direction is used. As a result, the cholesteric liquid crystal layer having the region where the optical axis 40A continuous rotates in the one direction and the length of the single period decreases in the one direction is formed.

For the application of the liquid crystal composition, a printing method such as ink jet or scroll printing or a well-known method such as spin coating, bar coating, or spray coating capable of uniformly applying liquid to a sheet-shaped material can be used.

The applied liquid crystal composition is optionally dried and/or heated and then is cured to form the liquid crystal layer. In the drying and/or heating step, the liquid crystal compound 40 in the liquid crystal composition may be aligned to a cholesteric liquid crystalline phase. In the case of heating, the heating temperature is preferably 200° C. or lower and more preferably 130° C. or lower.

The aligned liquid crystal compound 40 is optionally further polymerized. Regarding the polymerization, thermal polymerization or photopolymerization using light irradiation may be performed, and photopolymerization is preferable. Regarding the light irradiation, ultraviolet light is preferably used. The irradiation energy is preferably 20 to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 to 430 nm.

The cholesteric liquid crystal layer having the regions where the helical pitch PT varies in a plane can be formed, for example, by using the chiral agent in which back isomerization, dimerization, isomerization, dimerization or the like occurs during light irradiation such that the helical twisting power (HTP) changes and irradiating the liquid crystal composition with light having a wavelength at which the HTP of the chiral agent changes before or during the curing of the liquid crystal composition while changing the irradiation amount for each of the regions that vary in a plane.

For example, by using a chiral agent in which the HTP decreases during light irradiation, the HTP of the chiral agent decreases during light irradiation. Here, in a case where the irradiation amount of light for each of the regions changes, for example, in a region where the irradiation amount is large, the decrease in HTP is large, the induction of helix is small, and thus the helical pitch PT increases. On the other hand, for example, in a region where the irradiation amount is small, the decrease in HTP is small, helix is induced by the original HTP of the chiral agent, and thus the helical pitch PT decreases.

The method of changing the irradiation amount of light depending on the regions is not particularly limited, and a method of irradiating light through a gradation mask, a method of changing the irradiation time depending on the regions, or a method of changing the irradiation intensity depending on the regions can be used.

The gradation mask refers to a mask in which a transmittance with respect to light for irradiation changes in a plane.

The thickness of the liquid crystal layer 34 is not particularly limited, and the thickness with which a required light reflectivity can be obtained may be appropriately set depending on the use of the diffraction element, the light reflectivity required for the liquid crystal layer, the material for forming the liquid crystal layer 34, and the like.

In the image display apparatus 10 according to the embodiment of the present invention, the wavelength range of the light that is selectively reflected by the (cholesteric) liquid crystal layer 34 of the polarization diffraction element 18 is not particularly limited and may be appropriately set depending on the use of the image display apparatus and the like.

That is, the liquid crystal layer 34 in the example shown in the drawing selectively reflects green light, but the present invention is not limited thereto. In the polarization diffraction element 18, the liquid crystal layer 34 that acts as a reflective polarization diffraction element may selectively reflect red light or may selectively reflect blue light.

In addition, the polarization diffraction element 18 in the example shown in the drawing includes one liquid crystal layer 34, but the present invention is not limited thereto. The polarization diffraction element may include a plurality of liquid crystal layers in which the selective reflection wavelength ranges are different from each other.

For example, the polarization diffraction element may include two liquid crystal layers including a liquid crystal layer that selectively reflects red light and a liquid crystal layer that selectively reflects green light. Alternatively, the polarization diffraction element may include two liquid crystal layers including a liquid crystal layer that selectively reflects green light and a liquid crystal layer that selectively reflects blue light. Further, the polarization diffraction element may include three liquid crystal layers including a liquid crystal layer that selectively reflects red light, a liquid crystal layer that selectively reflects green light, and a liquid crystal layer that selectively reflects blue light.

In addition, the polarization diffraction element may include two or more liquid crystal layers with respect to one selective reflection wavelength range.

In a case where the polarization diffraction element includes a plurality of liquid crystal layers, it is preferable that an image projection element that displays an image using two colors or a full color image using three colors is also used as the image projection element.

In other words, in a case where the image projection element displays an image using two colors or a full color image using three colors, it is preferable that the polarization diffraction element includes two or three liquid crystal layers.

Here, as described above, in the liquid crystal layer having the liquid crystal alignment pattern, as the single period Λ decreases, the diffraction angle of reflected light with respect to the incidence light increases. That is, in the liquid crystal layer, as the single period Λ decreases, reflected light can be largely diffracted with respect to incidence light to be reflected in a direction that is different from specular reflection.

In addition, in the liquid crystal layer having the liquid crystal alignment pattern, the reflection angle (diffraction angle) of light varies depending on the wavelength of light that is selectively reflected, that is, the tilted surface pitch P (helical pitch). Specifically, in the liquid crystal layer, as the tilted surface pitch P increases, that is, as the wavelength of light increases, the diffraction angle of reflected light with respect to incidence light increases.

In consideration of this point, in the image display apparatus according to the embodiment of the present invention, in a case where the polarization diffraction element includes a plurality of liquid crystal layers in which the tilted surface pitches P are different from each other, it is preferable that a permutation of the tilted surface pitches P of the liquid crystal layers and a permutation of the single periods Λ match each other.

For example, the polarization diffraction element includes a laminate where a first cholesteric liquid crystal layer, a second cholesteric liquid crystal layer, and a third cholesteric liquid crystal layer each of which is provided in the liquid crystal layer are laminated, the first cholesteric liquid crystal layer has a region where blue light is selectively reflected and diffracted, the second cholesteric liquid crystal layer has a region where green light is selectively reflected and diffracted, and the third cholesteric liquid crystal layer has a region where red light is selectively reflected and diffracted.

Here, the helical pitch PT of the first cholesteric liquid crystal layer that selectively reflects blue light is the shortest, the helical pitch PT of the second cholesteric liquid crystal layer that selectively reflects green light is the second shortest, and the helical pitch PT of the third cholesteric liquid crystal layer that selectively reflects red light is the longest.

In this case, it is preferable that, in all of the first cholesteric liquid crystal layer, the second cholesteric liquid crystal layer, and the third cholesteric liquid crystal layer, the helical pitches PT are different from each other and the lengths of the single periods Λ in the liquid crystal alignment patterns are different from each other at any one in-plane point of the polarization diffraction element.

More specifically, it is preferable that, in a case where the lengths of the single periods A of the first cholesteric liquid crystal layer, the second cholesteric liquid crystal layer, and the third cholesteric liquid crystal layer at the one in-plane point are represented by Λ₁, Λ₂, and Λ₃, respectively, Λ₁<Λ₂<Λ₃ is satisfied. That is, it is preferable that a single period Λ₁ of the first cholesteric liquid crystal layer having the shortest helical pitch PT is the shortest, a single period Λ₂ of the second cholesteric liquid crystal layer having the second shortest helical pitch PT is the second shortest, and a single period Λ₃ of the third cholesteric liquid crystal layer having the longest helical pitch PT is the longest.

With the above-described configuration, the reflection directions of the virtual images A of the colors that are reflected by the polarization diffraction element to the observation position by the user U can be made to be the same. As a result, a color image having no color shift can be emitted to the observation position by the user U as the virtual image A.

In a case where the polarization diffraction element includes a plurality of liquid crystal layers in which the selective reflection wavelength ranges are different from each other, turning directions of circularly polarized light to be reflected by the respective liquid crystal layers may be the same as or different from each other.

However, in a case where the polarization diffraction element includes a plurality of liquid crystal layers in which the selective reflection wavelength ranges are different from each other, in a case where a combination of liquid crystal layers where the selective reflection wavelength ranges are adjacent to each other is present, it is preferable that turning directions of circularly polarized light to be selectively reflected from the liquid crystal layers forming the combination are opposite to each other.

For example, it is assumed that the polarization diffraction element include two liquid crystal layers including a liquid crystal layer that selectively reflects green light and a liquid crystal layer that selectively reflects red light. In this case, red light may be incident into and reflected by the liquid crystal layer that selectively reflects green light, and green light may be incident into and reflected by the liquid crystal layer that selectively reflects red light. This phenomenon is likely to occur in particular in the liquid crystal layers where the selective reflection wavelength ranges are adjacent to each other.

As described above, in a case where a plurality of liquid crystal layers where the selective reflection wavelength ranges are different are present, it is preferable that the single periods Λ of the liquid crystal alignment patterns are different from each other. In addition, in a case where light having the same wavelength is incident into the liquid crystal layers where the single periods Λ are different, the diffraction angles of light to be reflected and diffracted are different.

Accordingly, in the above-described case, in a case where red light is reflected from the liquid crystal layer that selectively reflects green light, the red light is reflected in a direction different from a direction in which the red light should be originally reflected, and stray light (crosstalk) occurs. Likewise, in a case where green light is reflected by the liquid crystal layer that selectively reflects red light, the green light is reflected in a direction different from a direction in which the green light should be originally reflected, and stray light occurs. As a result, the red light and/or the green light is reflected to an inappropriate position different from an appropriate position of the observation position by the user U such that double images occur.

On the other hand, in a case where the polarization diffraction element includes a plurality of liquid crystal layers in which the selective reflection wavelength ranges are different from each other, a turning direction of circularly polarized light to be selectively reflected from one of the liquid crystal layers is set to be opposite to a turning direction of circularly polarized light to be selectively reflected from the other liquid crystal layer. As a result, reflection (stray light) of light in an unintended wavelength range can be suppressed in each of the liquid crystal layers, and the occurrence of double images can be prevented.

In the above-described case, it is preferable that a rotation direction of the orientation of the optical axis that continuously rotates in the one direction in the liquid crystal alignment pattern of one cholesteric liquid crystal layer is opposite to that of the other cholesteric liquid crystal layer. The reason for this is that reflected light components reflected from both of the liquid crystal layers are emitted to appropriate observation positions.

For example, it is assumed that the polarization diffraction element is the above-described laminate consisting of the first cholesteric liquid crystal layer that selectively reflects and diffracts blue light, the second cholesteric liquid crystal layer that selectively reflects and diffracts green light, and the third cholesteric liquid crystal layer that selectively reflects and diffracts red light.

In this case, it is preferable that a rotation direction of the orientation of the optical axis that continuously rotates in the one direction in the liquid crystal alignment pattern of the second cholesteric liquid crystal layer is opposite to both of a rotation direction of the orientation of the optical axis that continuously rotates in the one direction in the liquid crystal alignment pattern of the first cholesteric liquid crystal layer and a rotation direction of the orientation of the optical axis that continuously rotates in the one direction in the liquid crystal alignment pattern of the third cholesteric liquid crystal layer. In this case, the rotation direction of the orientation of the optical axis in the liquid crystal alignment pattern of the first cholesteric liquid crystal layer and the rotation direction of the orientation of the optical axis in the liquid crystal alignment pattern of the third cholesteric liquid crystal layer are the same. Further, it is preferable that a turning direction of the helical structure in the second cholesteric liquid crystal layer is opposite to both of a turning direction of the helical structure in the first cholesteric liquid crystal layer and a turning direction of the helical structure in the third cholesteric liquid crystal layer. In this case, the turning direction of the helical structure in the first cholesteric liquid crystal layer and the turning direction of the helical structure in the third cholesteric liquid crystal layer are the same. As a result, reflection (stray light) of light in an unintended wavelength range can be suppressed in each of the first, second, and third cholesteric liquid crystal layers, and the occurrence of double images can be prevented.

In a case where the turning direction of the helical structure in the second cholesteric liquid crystal layer is opposite to the turning directions of the helical structures in the first cholesteric liquid crystal layer and the third cholesteric liquid crystal layer, an orientation of linearly polarized light projected from the image projection element or an orientation of circularly polarized light converted by the retardation plate may be appropriately set such that light (green light) in the selective wavelength range of the second cholesteric liquid crystal layer is reflected and diffracted.

In addition, an aspect where the polarization diffraction element includes the first cholesteric liquid crystal layer and the second cholesteric liquid crystal layer each of which is provided in the cholesteric liquid crystal layer may be adopted.

Further, an aspect where a wavelength range of light that is selectively reflected from the first cholesteric liquid crystal layer overlaps a wavelength range of light that is selectively reflected from the second cholesteric liquid crystal layer may be adopted.

In the polarization diffraction element, it is preferable that the rotation direction of the orientation of the optical axis that continuously rotates in the one direction in the liquid crystal alignment pattern of the first cholesteric liquid crystal layer is opposite to the rotation direction of the orientation of the optical axis that continuously rotates in the one direction in the liquid crystal alignment pattern of the second cholesteric liquid crystal layer, and the turning direction of the helical structure in the first cholesteric liquid crystal layer is opposite to the turning direction of the helical structure in the second cholesteric liquid crystal layer. The reason for this is that a range (Eyebox) where a user who uses the image display apparatus can appropriately observe a virtual image can be widened.

A method of setting the rotation direction of the orientation of the optical axis that continuously rotates in the one direction in the liquid crystal alignment pattern and a method of setting the turning direction of the helical structure in the cholesteric liquid crystal layer are as described above.

Examples of the combination of the first cholesteric liquid crystal layer and the second cholesteric liquid crystal layer where the wavelength ranges of selectively reflected light overlap each other include a combination of two cholesteric liquid crystal layers selected such that the overlapping reflection wavelength range is included in any of the wavelength range (420 to 490 nm) of blue light, the wavelength range (495 to 570 nm) of green light, and the wavelength range (620 to 750 nm) of red light.

### [Action of Image Display Apparatus]

Hereinafter, the action of the image display apparatus according to the embodiment of the present invention will be described using the image display apparatus 10 shown in FIG. 1 as an example.

In a case where the image projection element 12 of the image display apparatus 10 projects an image linearly polarized light of green light as the virtual image A (an image that forms the virtual image A), the virtual image A of linearly polarized light projected by the image projection element 12 is converted into right circularly polarized light by the retardation plate 14.

The virtual image A of right circularly polarized light that is converted by the retardation plate 14 is emitted to the observation position by the user U by the liquid crystal layer 34 of the polarization diffraction element 18.

Here, in the image display apparatus 10 according to the embodiment of the present invention, the cholesteric liquid crystal layer 34 of the polarization diffraction element 18 has the above-described liquid crystal alignment pattern, has the region where the single period Λ of the liquid crystal alignment pattern decreases in the direction away from the image projection element 12, and has the regions where the helical pitch PT varies in a plane.

Therefore, in the image display apparatus 10 according to the embodiment of the present invention, on the entire surface of the polarization diffraction element 18, the virtual image A projected by the image projection element 12 can be appropriately emitted to the observation position by the user U, the effect of blue shift where the wavelength of light to be selectively reflected shifts to a shorter wavelength can be reduced, and in-plane brightness unevenness of the polarization diffraction element 18 can be suppressed.

In addition, in the image display apparatus 10, the real scene R transmits through the transparent substrate 16 and the polarization diffraction element 18 to be observed by the user U. Asa result, the user U of the image display apparatus 10 observes augmented reality where the virtual image A is superimposed on the real scene R.

Here, the (cholesteric) liquid crystal layer 34 of the polarization diffraction element 18 is, for example, a reflective polarization diffraction element that reflects only right circularly polarized light of green light and allows transmission of the other light. Accordingly, in the real scene R, only right circularly polarized light of green light is reflected by the liquid crystal layer 34, and the other light transmits through the polarization diffraction element 18 and reaches the observation position by the user U.

In addition, in a case where the polarization diffraction element 18 includes three liquid crystal layers 34 that correspond to and reflect red light, green light, and blue light, circularly polarized light having a turning direction opposite to that of circularly polarized light reflected by each of the liquid crystal layers 34 transmits through the polarization diffraction element 18.

That is, in the image display apparatus 10 according to the embodiment of the present invention that reflects the virtual image A using the polarization diffraction element, even in a case where the reflectivity of the liquid crystal layer 34 is improved to increase the brightness of the virtual image A, it is not necessary to decrease the brightness of the real scene R. In addition, circularly polarized light having a turning direction opposite to that of circularly polarized light reflected by the liquid crystal layer 34 transmits through the polarization diffraction element 18. Therefore, a decrease in the brightness of the real scene R by the polarization diffraction element 18 is half or less.

Accordingly, in the image display apparatus 10 according to the embodiment of the present invention, the user U can observe augmented reality where the virtual image A is superimposed on the bright real scene R.

The image display apparatus according to the embodiment of the present invention is not limited to the configuration of the image display apparatus 10 shown in FIG. 1. FIGS. 10 to 12 are diagrams conceptually showing other examples of configurations of the image display apparatus according to the embodiment of the present invention.

In FIGS. 10 to 12, the same members as those in FIG. 1 are represented by the same references. The members represented by the same reference numerals have the same functions, and thus the description thereof will not be repeated.

An image display apparatus 10A shown in FIG. 10 includes the image projection element 12, the transparent substrate 16, and the polarization diffraction element 18. The image projection element 12 shown in FIG. 10 is a spatial light modulator (SLM) that converts a light beam.

As indicated by an arrow in FIG. 10, the virtual image A projected by the image projection element 12 is reflected by the cholesteric liquid crystal layer (not shown) of the polarization diffraction element 18, and is emitted to the observation position by the user U.

An image display apparatus 10B shown in FIG. 11 includes the image projection element 12, a MEMS mirror 20, the transparent substrate 16, and the polarization diffraction element 18.

The MEMS mirror 20 is a MEMS type spatial light modulator that swings a mirror using a piezoelectric actuator to deflect light (deflection scanning).

As indicated by an arrow in FIG. 11, the virtual image A projected by the image projection element 12 is reflected by the MEMS mirror 20, is reflected by the cholesteric liquid crystal layer (not shown) of the polarization diffraction element 18, and is emitted to the observation position by the user U.

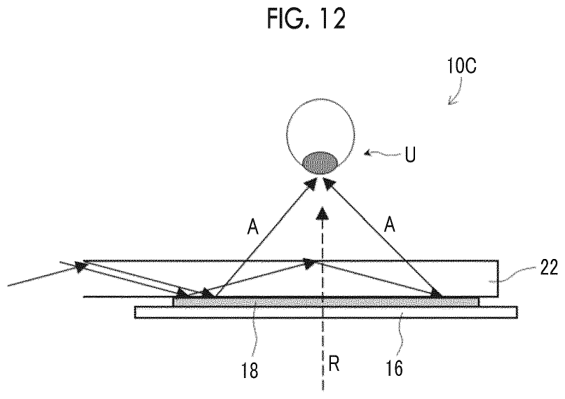

An image display apparatus 10C shown in FIG. 12 includes a light guide plate 22, the transparent substrate 16, and the polarization diffraction element 18.

The light guide plate 22 is a member having a function of causing (virtual image) emitted from the image projection element (not shown) to propagate in the light guide plate 22. The polarization diffraction element 18 is disposed on a surface of the light guide plate 22 opposite to the user U side.

In the image display apparatus 10C shown in FIG. 12, as indicated by an arrow, the virtual image A projected by the image projection element (not shown) propagates in the light guide plate 22, is reflected by the cholesteric liquid crystal layer (not shown) of the polarization diffraction element 18, and is emitted to the observation position by the user U.

Even any of the image display apparatuses shown in FIGS. 10 to 12, the cholesteric liquid crystal layer of the polarization diffraction element 18 has the above-described predetermined liquid crystal alignment pattern. As a result, as indicated by the arrow in each of the drawings, the same effects as those of the image display apparatus shown in FIG. 1 are exhibited, in that on the entire surface of the polarization diffraction element, the virtual image A projected by the image projection element can be appropriately emitted to the observation position by the user U, the effect of blue shift where the wavelength of light to be selectively reflected shifts to a shorter wavelength can be reduced, and in-plane brightness unevenness of the polarization diffraction element can be suppressed.

Hereinabove, the image display apparatus and the AR glasses according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Comparative Example 1

### <Preparation of Reflective Liquid Crystal Diffraction Element>

### (Support)

A glass substrate was used as the support.

### (Formation of Alignment Film)

The following coating liquid for forming an alignment film was applied to the support by spin coating. The support on which the coating film of the coating liquid for forming an alignment film was formed was dried using a hot plate at 60° C. for 60 seconds. As a result, an alignment film was formed.

Coating Liquid for Forming Alignment Film

| | | |
|---|---|---|
| Material A for photo-alignment | 1.00 | part by mass |
| Water | 16.00 | parts by mass |
| Butoxyethanol | 42.00 | parts by mass |
| Propylene glycol monomethyl ether | 42.00 | parts by mass |

Material A for Photo-Alignment

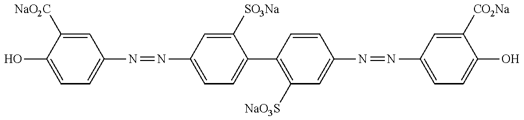

### (Exposure of Alignment Film)

The alignment film was exposed using the exposure device shown in FIG. 9 to form an alignment film P-G1 having an alignment pattern.

In the exposure device, a laser that emits laser light having a wavelength (355 nm) was used as the laser. The exposure amount of the interference light was 1000 mJ/cm². An intersecting angle (intersecting angle α) between two light components and a lens shape were changed, and the exposure was controlled to obtain an alignment film where a single period of an alignment pattern changed in one in-plane direction.

### (Formation of Cholesteric Liquid Crystal Layer)

As a liquid crystal composition for forming a cholesteric liquid crystal layer G1, the following composition G-1 was prepared.

Composition G-1

| | | |
|---|---|---|
| Liquid crystal compound L-1 | 100.00 | parts by mass |
| Chiral agent C1 | 5.60 | parts by mass |
| Polymerization initiator I-1 | 3.00 | parts by mass |
| Surfactant F1 | 0.02 | parts by mass |
| Surfactant F2 | 0.20 | parts by mass |
| Methyl ethyl ketone | 120.58 | parts by mass |
| Cyclopentanone | 80.38 | parts by mass |

Liquid Crystal Compound L-1 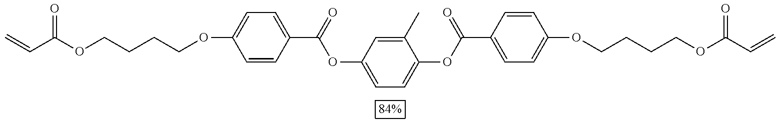 [SMILES: C=CC(=O)OCCCCOc1ccc(C(=O)Oc2ccc(OC(=O)c3ccc(OCCCCOC(=O)C=C)cc3)c(C)c2)cc1] 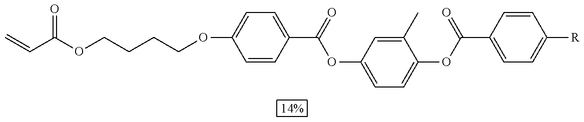 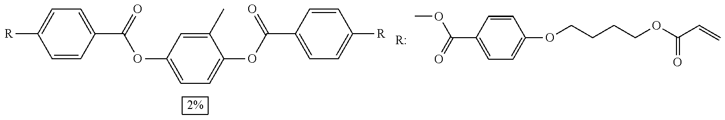
Chiral Agent C1 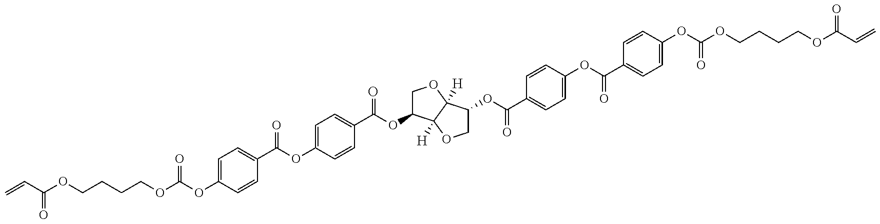 [SMILES: C=CC(=O)OCCCCOC(=O)Oc1ccc(C(=O)Oc2ccc(C(=O)O[C@H]3CO[C@@H]4[C@H]3OC[C@H]4OC(=O)c3ccc(OC(=O)c4ccc(OC(=O)OCCCCOC(=O)C=C)cc4)cc3)cc2)cc1]
Polymerization Initiator I-1 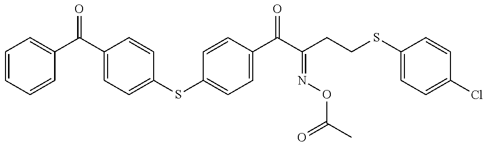 [SMILES: CC(=O)O/N=C(\CCSc1ccc(Cl)cc1)C(=O)c1ccc(Sc2ccc(C(=O)c3ccccc3)cc2)cc1]
Surfactant F1 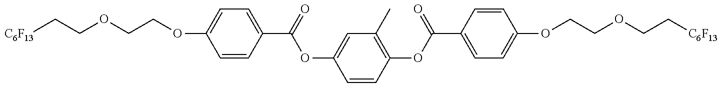
Surfactant F2

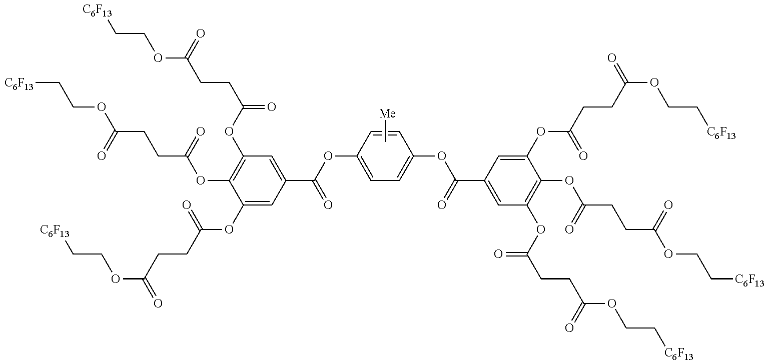

The cholesteric liquid crystal layer G1 was formed by applying the composition G-1 to a photo-alignment film. Specifically, the composition G-1 was applied to the alignment film P-G1 by spin coating, and the coating film was heated on a hot plate at 120° C. for 120 seconds. Next, the coating film was irradiated with ultraviolet light having a wavelength of 365 nm at an irradiation amount of 500 mJ/cm² using a high-pressure mercury lamp in a nitrogen atmosphere. As a result, the alignment of the liquid crystal compound was immobilized, and a cholesteric liquid crystal layer G1 (reflective liquid crystal diffraction element G1) was formed.

The obtained cholesteric liquid crystal layer G1 (reflective liquid crystal diffraction element G1) was an optical element for reflecting right circularly polarized light.

It was verified using a polarization microscope that the cholesteric liquid crystal layer G1 had a periodic alignment pattern.

The cholesteric liquid crystal layer G1 was cut in one in-plane direction in which the optical axis of the liquid crystal compound changed while continuously rotating, and the exposed cross section was verified with a SEM. As a result, in the liquid crystal alignment pattern of the cholesteric liquid crystal layer G1, regarding the single period Λ where the optical axis of the liquid crystal compound rotated by 180°, the single period Λ at a position P1 (hereinafter, also simply referred to as “position P1”) at a distance of 5 mm from one end part (hereinafter, also referred to as “end part A”) of the cholesteric liquid crystal layer G1 was 2.67 μm, the single period Λ at a position P2 (hereinafter, also simply referred to as “position P2”) at a distance of 20 mm from the end part A was 0.59 μm, and the single period Λ at a position P3 (hereinafter, also simply referred to as “position P3”) at a distance of 35 mm from the end part A was 0.33 μm. This way, the liquid crystal alignment pattern in the cholesteric liquid crystal layer G1 was the liquid crystal alignment pattern where the single period Λ decreased in the one direction from one end part (end part A) to another end part (hereinafter, also referred to as “end part B”).

In addition, as a result of the cross section observation of the cholesteric liquid crystal layer G1 by the SEM, the length (helical pitch PT) of one pitch of the helical structure in the cholesteric liquid crystal layer G1 was 342 nm at all the positions P1, P2, and P3.

In Examples, the helical pitch PT of the cholesteric liquid crystal layer at each of the distances was calculated based on an interval in the normal direction of lines represented by bright portions and dark portions derived from a cholesteric liquid crystalline phase that were observed in a case where the cross section of the cholesteric liquid crystal layer was observed with the SEM. That is, in a case where the bright portions and the dark portions were tilted with respect to the main surface of the cholesteric liquid crystalline phase, the helical pitch PT was a value calculated based on the above-described tilted surface pitch. In addition, the helical pitch PT at the predetermined distance from the end part was obtained by calculating an arithmetic mean value of the pitches (tilted surface pitches) of the helical structure in the cholesteric liquid crystal layer in the thickness direction.

### <Preparation of Optical Element>

A temporary support was bonded to a cholesteric liquid crystal layer G1-side surface of the glass substrate with the prepared cholesteric liquid crystal layer G1 (reflective liquid crystal diffraction element G1). Next, by peeling off the cholesteric liquid crystal layer G and the temporary support from the glass substrate and the alignment film, the cholesteric liquid crystal layer G1 was transferred to the temporary support to obtain a laminate G1.

A glass substrate where an antireflection layer was formed on a surface was separately prepared. The laminate G1 was bonded to the glass substrate with the antireflection layer such that the cholesteric liquid crystal layer G1 came into contact with the surface of the glass substrate opposite to the antireflection layer. Next, the temporary support was peeled off from the cholesteric liquid crystal layer G1 to obtain an optical element 1 that was the laminate including the cholesteric liquid crystal layer G1, the glass substrate, and the antireflection layer in this order.

### Example 1

### <Preparation of Reflective Liquid Crystal Diffraction Element>

### (Formation of Alignment Film)

The alignment film P-G1 was formed using the same method as that of Comparative Example 1.

### (Formation of Cholesteric Liquid Crystal Layer)

As a liquid crystal composition for forming a cholesteric liquid crystal layer G2, the following composition G-2 was prepared.

Composition G-2

| | | |
|---|---|---|
| Liquid crystal compound L-1 | 100.00 | parts by mass |
| Chiral agent C1 | 6.00 | parts by mass |
| Chiral agent C3 | 2.00 | parts by mass |
| Polymerization initiator I-1 | 3.00 | parts by mass |
| Surfactant F1 | 0.02 | parts by mass |
| Surfactant F2 | 0.20 | parts by mass |
| Methyl ethyl ketone | 120.58 | parts by mass |
| Cyclopentanone | 80.38 | parts by mass |

Chiral Agent C3

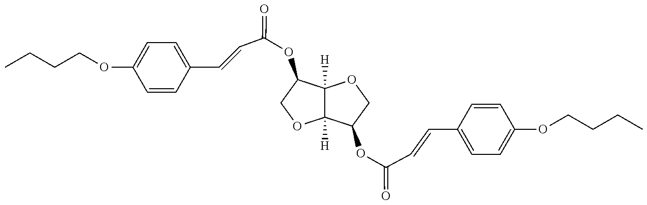

The cholesteric liquid crystal layer G2 was formed by applying the composition G-2 to a photo-alignment film. Specifically, the composition G-2 was applied to the alignment film P-G1 by spin coating, and the coating film was heated on a hot plate at 120° C. for 120 seconds. Next, the coating film was irradiated with ultraviolet light having a wavelength of 365 nm using a LED-UV exposure device. In this case, the coating film was irradiated while changing the irradiation amount of ultraviolet light in a plane. Specifically, the coating film was irradiated by changing the irradiation amount in a plane such that the irradiation amount decreased from one end part toward another end part of the coating film. Next, the coating film heated on the hot plate at 120° C. was irradiated with ultraviolet light having a wavelength of 365 nm at an irradiation amount of 500 mJ/cm² using a high-pressure mercury lamp in a nitrogen atmosphere. As a result, the alignment of the liquid crystal compound was immobilized, and a cholesteric liquid crystal layer G2 (reflective liquid crystal diffraction element G2) was formed.

The obtained cholesteric liquid crystal layer G2 (reflective liquid crystal diffraction element G2) was an optical element for reflecting right circularly polarized light. In addition, it was verified using a polarization microscope that the cholesteric liquid crystal layer G2 had the periodic alignment pattern shown in FIG. 2.

The cholesteric liquid crystal layer G2 was cut in one in-plane direction in which the optical axis of the liquid crystal compound changed while continuously rotating, and the exposed cross section was verified with a SEM. As a result, in the liquid crystal alignment pattern of the cholesteric liquid crystal layer G2, regarding the single period Λ where the optical axis of the liquid crystal compound rotated by 180°, the single period Λ at the position P1 of the cholesteric liquid crystal layer G2 was 2.67 μm, the single period Λ at the position P2 was 0.59 μm, and the single period Λ at the position P3 was 0.33 μm. This way, the liquid crystal alignment pattern in the cholesteric liquid crystal layer G2 was the liquid crystal alignment pattern where the period decreased in the one direction from the end part A to the end part B.

In addition, as a result of the cross section observation of the cholesteric liquid crystal layer G2 by the SEM, regarding the length (helical pitch PT) of one pitch of the helical structure in the cholesteric liquid crystal layer G2, the helical pitch PT at the position P1 was 328 nm, the helical pitch PT at the position P2 was 342 nm, and the helical pitch PT at the position P3 was 436 nm. This way, the helical pitch PT in the cholesteric liquid crystal layer G2 increased in the one direction from the end part A to the end part B.

### <Preparation of Optical Element>

An optical element 2 including the cholesteric liquid crystal layer G2, the glass substrate, and the antireflection layer in this order was prepared using the same method as that of the preparation of the optical element according to Comparative Example 1, except that the cholesteric liquid crystal layer G1 (reflective liquid crystal diffraction element G1) was changed to the cholesteric liquid crystal layer G2 (reflective liquid crystal diffraction element G2).

### [Evaluation]

In a case where light was incident into the prepared optical element from an oblique direction (angle with respect to the normal line), the intensity of reflected light was evaluated.

Specifically, the prepared optical element was irradiated with laser light L having an output center wavelength of 532 nm from alight source. The irradiation angle (incidence angle) of the laser light was an angle of 65° from the normal line of the prepared optical element. The laser light emitted from the light source was vertically incident into a circular polarization plate corresponding to the wavelength of the laser light to be converted into circularly polarized light, and the obtained circularly polarized light was incident from the reflective liquid crystal diffraction element side into the optical element. This circularly polarized light was incident into each of the position P1 at a distance of 5 mm from the end part A close to the above-described light source of the cholesteric liquid crystal layer in the reflective liquid crystal diffraction element, the position P2 at a distance of 20 mm from the end part A, and the position P3 at a distance of 35 mm from the end part A to perform the following evaluation.

Among the reflected light components reflected from the respective positions of the reflective liquid crystal diffraction element, the intensity of diffracted light (first-order light) diffracted in a desired direction from the reflective liquid crystal diffraction element was measured using a photodetector. The angle of reflected light that was reflected from the position P1 of the cholesteric liquid crystal layer and was measured by the photodetector was an angle of +45° from the normal line of the prepared optical element. Likewise, the angles of reflected light components that were reflected from the position P2 and the position P3 of the cholesteric liquid crystal layer were 0° and −45° from the normal line of the optical element, respectively.

In a case where light is incident into the position P2 of the cholesteric liquid crystal layer, the amounts of diffracted light reflected from the optical element 1 prepared in Comparative Example 1 and the optical element 2 prepared in Example 1 were substantially the same. On the other hand, in a case where light is incident into the position P1 and the position P3 of the cholesteric liquid crystal layer, the amount of diffracted light reflected from the optical element 2 according to Example 1 was increased as compared to the optical element 1 according to Comparative Example 1.

As a result, in the optical element 2 according to Example 1, a difference between the amount of reflected light reflected from the position P1 or the position P3 of the cholesteric liquid crystal layer and the amount of reflected light reflected from the position P2 of the cholesteric liquid crystal layer was decreased as compared to the optical element 1 according to Comparative Example 1. That is, it was found that, in the optical element 2 according to Example 1, even in a case where incidence light is reflected at different angles in different in-plane regions having different distances from the image projection element of the polarization diffraction element, the amount of reflected light is likely to be more uniform in a plane, and in-plane brightness unevenness of the observation image was further reduced.

### Comparative Example 2

### <Preparation of Reflective Liquid Crystal Diffraction Element>

### (Formation and Exposure of Photo-Alignment Film for Cholesteric Liquid Crystal Layer B1)

Using the same method as that of the formation of the photo-alignment film for the cholesteric liquid crystal layer G1 according to Comparative Example 1, a photo-alignment film was formed on a surface of a support formed of glass.

The photo-alignment film was exposed using the exposure device shown in FIG. 9 to form an alignment film P-B1 having a predetermined alignment pattern using the same method as that of Comparative Example 1, except that an intersecting angle (intersecting angle α) between two light components and a lens shape were changed to obtain an alignment film where the length of the single period of the alignment pattern and the degree of an in-plane change in the length of the single period thereof were changed from the formed photo-alignment film.

### (Formation of Cholesteric Liquid Crystal Layer B1)

A composition B-1 was prepared using the same method as that of the composition G-1, except that the addition amount of the chiral agent C1 of the composition G-1 was changed to 6.50 parts by mass.

A cholesteric liquid crystal layer B1 (reflective liquid crystal diffraction element B1) was formed using the same method as that of the formation of the cholesteric liquid crystal layer G1 according to Comparative Example 1, except that the alignment film P-B1 was used instead of the alignment film P-G1, the composition B-1 was used instead of the composition G-1, and the thickness of the coating film of the composition B-1 was adjusted.

The obtained cholesteric liquid crystal layer B1 (reflective liquid crystal diffraction element B1) was an optical element for reflecting right circularly polarized light. It was verified using a polarization microscope that the cholesteric liquid crystal layer B1 had a periodic alignment pattern.

The cholesteric liquid crystal layer B1 was cut in one in-plane direction in which the optical axis of the liquid crystal compound changed while continuously rotating, and the exposed cross section was verified with a SEM. As a result, in the liquid crystal alignment pattern of the cholesteric liquid crystal layer B1, regarding the single period Λ where the optical axis of the liquid crystal compound rotated by 180°, the single period Λ at the position P1 of the cholesteric liquid crystal layer B1 was 2.26 μm, the single period Λ at the position P2 was 0.50 μm, and the single period Λ at the position P3 was 0.28 μm. This way, the liquid crystal alignment pattern in the cholesteric liquid crystal layer B1 was a liquid crystal alignment pattern where the single period Λ decreased in the above-described one direction from one end part (end part A) to another end part (end part B).

In addition, as a result of the cross section observation of the cholesteric liquid crystal layer B1 by the SEM, the length (helical pitch PT) of one pitch of the helical structure in the cholesteric liquid crystal layer B1 was 289 nm at all the positions P1, P2, and P3.

### (Formation and Exposure of Photo-Alignment Film for Cholesteric Liquid Crystal Layer R1)

Using the same method as that of the formation of the photo-alignment film for the cholesteric liquid crystal layer G1 according to Comparative Example 1, a photo-alignment film was formed on a surface of a support formed of glass.

The photo-alignment film was exposed using the exposure device shown in FIG. 9 to form an alignment film P-R1 having a predetermined alignment pattern using the same method as that of Comparative Example 1, except that an intersecting angle (intersecting angle α) between two light components and a lens shape were changed to obtain an alignment film where the length of the single period of the alignment pattern and the degree of an in-plane change in the length of the single period thereof were changed from the formed photo-alignment film.

### (Formation of Cholesteric Liquid Crystal Layer R1)

A composition R-1 was prepared using the same method as that of the composition G-1, except that the addition amount of the chiral agent C1 of the composition G-1 was changed to 6.50 parts by mass.

A cholesteric liquid crystal layer R1 (reflective liquid crystal diffraction element R1) was formed using the same method as that of the formation of the cholesteric liquid crystal layer G1 according to Comparative Example 1, except that the alignment film P-R1 was used instead of the alignment film P-G1, the composition R-1 was used instead of the composition G-1, and the thickness of the coating film of the composition R-1 was adjusted.

The obtained cholesteric liquid crystal layer R1 (reflective liquid crystal diffraction element R1) was an optical element for reflecting right circularly polarized light. It was verified using a polarization microscope that the cholesteric liquid crystal layer R1 had a periodic alignment pattern.

The cholesteric liquid crystal layer R1 was cut in one in-plane direction in which the optical axis of the liquid crystal compound changed while continuously rotating, and the exposed cross section was verified with a SEM. As a result, in the liquid crystal alignment pattern of the cholesteric liquid crystal layer B1, regarding the single period Λ where the optical axis of the liquid crystal compound rotated by 180°, the single period Λ at the position P1 of the cholesteric liquid crystal layer B1 was 3.18 μm, the single period Λ at the position P2 was 0.70 μm, and the single period Λ at the position P3 was 0.39 μm. This way, the liquid crystal alignment pattern in the cholesteric liquid crystal layer R1 was a liquid crystal alignment pattern where the single period Λ decreased in the above-described one direction from one end part (end part A) to another end part (end part B).

In addition, as a result of the cross section observation of the cholesteric liquid crystal layer R1 by the SEM, the length (helical pitch PT) of one pitch of the helical structure in the cholesteric liquid crystal layer R1 was 406 nm at all the positions P1, P2, and P3.

### <Preparation of Optical Element>

A laminate B1 including the cholesteric liquid crystal layer B1 and the temporary support and a laminate R1 including the cholesteric liquid crystal layer R1 and the temporary support were prepared using the same method as that of the preparation of the optical element according to Comparative Example 1, except that the cholesteric liquid crystal layer G1 (reflective liquid crystal diffraction element G1) was changed to the cholesteric liquid crystal layer B1 (reflective liquid crystal diffraction element B1) or the cholesteric liquid crystal layer R1 (reflective liquid crystal diffraction element R1).

Next, a glass substrate with an antireflection layer was separately prepared using the same method as that of Comparative Example 1, the laminate R1 was bonded to the glass substrate with the antireflection layer such that the cholesteric liquid crystal layer R1 came into contact with the surface opposite to the antireflection layer, and the temporary support was peeled off from the cholesteric liquid crystal layer R1. As in the above-described case, the laminate G1 was bonded to the cholesteric liquid crystal layer R1, and the temporary support was peeled off from the cholesteric liquid crystal layer G1. Next, the laminate B1 was bonded to the cholesteric liquid crystal layer G1, and the temporary support was peeled off from the cholesteric liquid crystal layer B1. This way, an optical element 3 that was the laminate including the cholesteric liquid crystal layer B1, the cholesteric liquid crystal layer G1, the cholesteric liquid crystal layer R1, the glass substrate, and the antireflection layer in this order was prepared.

### Example 2

### <Preparation of Reflective Liquid Crystal Diffraction Element>

### (Formation and Exposure of Photo-Alignment Film for Cholesteric Liquid Crystal Layer B2)

The alignment film P-B1 was formed using the same method as that of Comparative Example 2.

### (Formation of Cholesteric Liquid Crystal Layer B2)

A composition B-2 that was a liquid crystal composition for forming a cholesteric liquid crystal layer B2 was prepared using the same method as the preparation method of the composition G-2 according to Example 1, except that the addition amount of the chiral agent C1 of the composition G-2 was changed to 7.00 parts by mass.

A cholesteric liquid crystal layer B2 (reflective liquid crystal diffraction element B2) was formed using the same method as that of the formation of the cholesteric liquid crystal layer G2 according to Example 1, except that the alignment film P-B1 was formed instead of the alignment film P-G1, the composition B-2 was used instead of the composition G-2, the thickness of the coating film of the composition B-2 was adjusted, and the irradiation amount of ultraviolet light in a plane in a case where the coating film was irradiated with ultraviolet light having a wavelength of 365 nm using an LED-UV exposure device was changed.

The obtained cholesteric liquid crystal layer B2 (reflective liquid crystal diffraction element B2) was an optical element for reflecting right circularly polarized light. In addition, it was verified using a polarization microscope that the cholesteric liquid crystal layer B2 had the periodic alignment pattern shown in FIG. 2.

The formed cholesteric liquid crystal layer B2 was cut in one in-plane direction in which the optical axis of the liquid crystal compound changed while continuously rotating, and the exposed cross section was verified with a SEM. As a result, in the liquid crystal alignment pattern of the cholesteric liquid crystal layer B2, regarding the single period Λ where the optical axis of the liquid crystal compound rotated by 180°, the single period Λ at the position P1 of the cholesteric liquid crystal layer B2 was 2.26 μm, the single period Λ at the position P2 was 0.50 μm, and the single period Λ at the position P3 was 0.28 μm. This way, the liquid crystal alignment pattern in the cholesteric liquid crystal layer B2 was a liquid crystal alignment pattern where the single period Λ decreased in the above-described one direction from one end part (end part A) to another end part (end part B).

In addition, as a result of the cross section observation of the cholesteric liquid crystal layer B2 by the SEM, regarding the length (helical pitch PT) of one pitch of the helical structure in the cholesteric liquid crystal layer B2, the helical pitch PT at the position P1 was 277 nm, the helical pitch PT at the position P2 was 289 nm, and the helical pitch PT at the position P3 was 368 nm. This way, the helical pitch PT in the cholesteric liquid crystal layer B2 increased in the one direction from the end part A to the end part B.

### (Formation and Exposure of Photo-Alignment Film for Cholesteric Liquid Crystal Layer R2)

The alignment film P-R1 was formed using the same method as that of Comparative Example 2.

### (Formation of Cholesteric Liquid Crystal Layer R2)

A composition R-2 that was a liquid crystal composition for forming a cholesteric liquid crystal layer R2 was prepared using the same method as the composition G-2 according to Example 1, except that the addition amount of the chiral agent C1 of the composition G-2 was changed to 5.30 parts by mass and the addition amount of the chiral agent C3 was changed to 2.50 parts by mass.

A cholesteric liquid crystal layer R2 was formed using the same method as that of the formation of the cholesteric liquid crystal layer G2 according to Example 1, except that the alignment film P-R1 was formed instead of the alignment film P-G1, the composition R-2 was used instead of the composition G-2, the thickness of the coating film of the composition R-2 was adjusted, and the irradiation amount of ultraviolet light in a plane in a case where the coating film was irradiated with ultraviolet light having a wavelength of 365 nm using an LED-UV exposure device was changed. (Reflective Liquid Crystal Diffraction Element R2)

The obtained cholesteric liquid crystal layer R2 (reflective liquid crystal diffraction element R2) was an optical element for reflecting right circularly polarized light. In addition, it was verified using a polarization microscope that the cholesteric liquid crystal layer R2 had the periodic alignment pattern shown in FIG. 2.

The formed cholesteric liquid crystal layer R2 was cut in one in-plane direction in which the optical axis of the liquid crystal compound changed while continuously rotating, and the exposed cross section was verified with a SEM. As a result, in the liquid crystal alignment pattern of the cholesteric liquid crystal layer R2, regarding the single period Λ where the optical axis of the liquid crystal compound rotated by 180°, the single period Λ at the position P1 of the cholesteric liquid crystal layer R2 was 3.18 μm, the single period Λ at the position P2 was 0.70 μm, and the single period Λ at the position P3 was 0.39 μm. This way, the liquid crystal alignment pattern in the cholesteric liquid crystal layer R2 was a liquid crystal alignment pattern where the single period Λ decreased in the above-described one direction from one end part (end part A) to another end part (end part B).

In addition, as a result of the cross section observation of the cholesteric liquid crystal layer R2 by the SEM, regarding the length (helical pitch PT) of one pitch of the helical structure in the cholesteric liquid crystal layer R2, the helical pitch PT at the position P1 was 390 nm, the helical pitch PT at the position P2 was 406 nm, and the helical pitch PT at the position P3 was 520 nm. This way, the helical pitch PT in the cholesteric liquid crystal layer R2 increased in the one direction from the end part A to the end part B.

### <Preparation of Optical Element>

An optical element 4 that was the laminate including the cholesteric liquid crystal layer B2, the cholesteric liquid crystal layer G2, the cholesteric liquid crystal layer R2, the glass substrate, and the antireflection layer in this order was prepared using the same method as that of the optical element according to Comparative Example 2, except that the cholesteric liquid crystal layer R1, the cholesteric liquid crystal layer G1, and the cholesteric liquid crystal layer B1 were changed to the cholesteric liquid crystal layer R2, the cholesteric liquid crystal layer G2, and the cholesteric liquid crystal layer B2, respectively.

### [Evaluation]

In a case where light was incident into the prepared optical element from an oblique direction (angle with respect to the normal line), the intensity of reflected light was evaluated.

Specifically, the prepared optical element was irradiated with laser light L having output center wavelengths of 450 nm, 532 nm, and 633 nm from a light source. The incidence angle of the laser light was an angle of 65° from the normal direction of the prepared optical element. In addition, the laser light emitted from the light source was vertically incident into a circular polarization plate corresponding to the wavelength of the laser light to be converted into circularly polarized light, and the obtained circularly polarized light was incident from the reflective liquid crystal diffraction element side into the optical element. This circularly polarized light was incident into each of the positions P1, P2, and P3 of the cholesteric liquid crystal layer in the reflective liquid crystal diffraction element to perform the following evaluation.

Among the reflected light components reflected from the respective positions of the reflective liquid crystal diffraction element, the intensity of diffracted light (first-order light) diffracted in a desired direction from the reflective liquid crystal diffraction element was measured using a photodetector.

In a case where light is incident into the position P2 of the cholesteric liquid crystal layer, the amounts of diffracted light reflected from the optical element 3 prepared in Comparative Example 2 and the optical element 4 prepared in Example 2 were substantially the same even any of the wavelengths of 450 nm, 532 nm, and 633 nm. On the other hand, in a case where light is incident into the positions P1 and P3 of the cholesteric liquid crystal layer, the amount of diffracted light reflected from the optical element 4 according to Example 2 was increased as compared to the optical element 3 according to Comparative Example 2 even any of the wavelengths of 450 nm, 532 nm, and 633 nm.

As a result, in the optical element 4 according to Example 1, a difference between the amount of reflected light reflected from the position P1 or the position P3 of the cholesteric liquid crystal layer and the amount of reflected light reflected from the position P2 of the cholesteric liquid crystal layer was decreased as compared to the optical element 3 according to Comparative Example 2. That is, it was found that, in the optical element 4 according to Example 3, even in a case where incidence light is reflected at different angles in different in-plane regions having different distances from the image projection element of the polarization diffraction element, the amount of reflected light is likely to be more uniform in a plane, and in-plane brightness unevenness of the observation image was further reduced.

### Example 3

### <Preparation of Reflective Liquid Crystal Diffraction Element>

### (Formation and Exposure of Photo-Alignment Film for Cholesteric Liquid Crystal Layer G3)

Using the same method as that of the formation of the photo-alignment film for the cholesteric liquid crystal layer G1 according to Comparative Example 1, a photo-alignment film was formed on a surface of a support formed of glass.

The photo-alignment film was exposed using the exposure device 60 shown in FIG. 9 to form an alignment film P-G2 having a predetermined alignment pattern using the same method as that of Comparative Example 1, except that an intersecting angle (intersecting angle α) between two light components and a lens shape were changed to obtain an alignment film where the length of the single period of the alignment pattern and the degree of an in-plane change in the length of the single period thereof were changed from the formed photo-alignment film, and the λ/4 plate 72A and the λ/4 plate 72B in the exposure device 60 shown in FIG. 9 were rotated by 90° to change the irradiated circularly polarized light to the opposite circularly polarized light.

### (Formation of Cholesteric Liquid Crystal Layer G3)

A composition G-3 that was a liquid crystal composition for forming a cholesteric liquid crystal layer G3 was prepared using the same method as the composition G-2 according to Example 1, except that the addition amount of the chiral agent C1 of the composition G-2 was changed to 0 parts by mass (that is, the chiral agent C1 was not added) and the addition amount of the chiral agent C3 was changed to 6.50 parts by mass.

A cholesteric liquid crystal layer G3 (reflective liquid crystal diffraction element G3) was formed using the same method as that of the formation of the cholesteric liquid crystal layer G2 according to Example 1, except that the composition G-3 was used instead of the composition G-2, and the irradiation amount of ultraviolet light in a plane in a case where the coating film was irradiated with ultraviolet light having a wavelength of 365 nm using an LED-UV exposure device was changed.

The obtained cholesteric liquid crystal layer G3 (reflective liquid crystal diffraction element G3) was an optical element for reflecting circularly polarized light (left circularly polarized light) opposite to that of the cholesteric liquid crystal layer G2. In addition, it was verified using a polarization microscope that the cholesteric liquid crystal layer G3 had the periodic alignment pattern shown in FIG. 2.

The cholesteric liquid crystal layer G3 was cut in one in-plane direction in which the optical axis of the liquid crystal compound changed while continuously rotating, and the exposed cross section was verified with a SEM. As a result, in the liquid crystal alignment pattern of the cholesteric liquid crystal layer G3, regarding the single period Λ where the optical axis of the liquid crystal compound rotated by 180°, the single period Λ at the position P1 of the cholesteric liquid crystal layer G3 was 2.67 μm, the single period Λ at the position P2 was 0.59 μm, and the single period Λ at the position P3 was 0.33 μm. This way, the liquid crystal alignment pattern in the cholesteric liquid crystal layer G2 was the liquid crystal alignment pattern where the period decreased in the one direction from the end part A to the end part B.

In addition, as a result of the cross section observation of the cholesteric liquid crystal layer G3 by the SEM, regarding the length (helical pitch PT) of one pitch of the helical structure in the cholesteric liquid crystal layer G3, the helical pitch PT at the position P1 was 328 nm, the helical pitch PT at the position P2 was 342 nm, and the helical pitch PT at the position P3 was 436 nm. This way, the helical pitch PT in the cholesteric liquid crystal layer G3 increased in the one direction from the end part A to the end part B.

### <Preparation of Optical Element>

An optical element 5 that was the laminate including the cholesteric liquid crystal layer B2, the cholesteric liquid crystal layer G3, the cholesteric liquid crystal layer R2, the glass substrate, and the antireflection layer in this order was prepared using the same method as that of the optical element according to Comparative Example 2, except that the cholesteric liquid crystal layer R1, the cholesteric liquid crystal layer G1, and the cholesteric liquid crystal layer B1 were changed to the cholesteric liquid crystal layer R2, the cholesteric liquid crystal layer G3, and the cholesteric liquid crystal layer B2, respectively.

### [Evaluation]

In a case where light was incident into the prepared optical element from an oblique direction (angle with respect to the normal line), the intensity of reflected light was evaluated.

Specifically, the prepared optical element was irradiated with laser light L having output center wavelengths of 450 nm, 532 nm, and 633 nm from a light source. The incidence angle of the laser light was an angle of 65° from the normal direction of the prepared optical element. In addition, the laser light emitted from the light source was vertically incident into a circular polarization plate corresponding to the wavelength of the laser light to be converted into circularly polarized light, and the obtained circularly polarized light was incident from the reflective liquid crystal diffraction element side into the optical element. This circularly polarized light was incident into each of the positions P1, P2, and P3 of the cholesteric liquid crystal layer in the reflective liquid crystal diffraction element to perform the following evaluation.

Among the reflected light components reflected from the respective positions of the reflective liquid crystal diffraction element, the intensity of diffracted light (first-order light) diffracted in a desired direction from the reflective liquid crystal diffraction element was measured using a photodetector. In the evaluation of the optical element 5 prepared in Example 3, circularly polarized light having a wavelength of 532 nm was converted into the opposite circularly polarized light (left circularly polarized light) to perform the evaluation.

In a case where light is incident into the position P2 of the cholesteric liquid crystal layer, the amounts of diffracted light reflected from the optical element 3 prepared in Comparative Example 2 and the optical element 5 prepared in Example 3 were substantially the same even any of the wavelengths of 450 nm, 532 nm, and 633 nm. On the other hand, in a case where light is incident into the positions P1 and P3 of the cholesteric liquid crystal layer, the amount of diffracted light reflected from the optical element 5 according to Example 3 was increased as compared to the optical element 3 according to Comparative Example 2 even any of the wavelengths of 450 nm, 532 nm, and 633 nm.

As a result, in the optical element 5 according to Example 3, a difference between the amount of reflected light reflected from the position P1 or the position P3 of the cholesteric liquid crystal layer and the amount of reflected light reflected from the position P2 of the cholesteric liquid crystal layer was decreased as compared to the optical element 3 according to Comparative Example 2. That is, it was found that, in the optical element 5 according to Example 3, even in a case where incidence light is reflected at different angles in different in-plane regions having different distances from the image projection element of the polarization diffraction element, the amount of reflected light is likely to be more uniform in a plane, and in-plane brightness unevenness of the observation image was further reduced.

In addition, in a case where light components having wavelengths of 450 nm, 532 nm, and 633 nm were incident, in stray light (crosstalk) that was reflected and diffracted in directions other than a desired direction from the reflective liquid crystal diffraction element, the amount of light in the optical element 4 according to Example 2 was less than that in the optical element 3 according to Comparative Example 2, and the amount of light in the optical element 5 according to Example 3 was much less than that in the optical element 3 according to Comparative Example 2. This way, in the optical element 4 according to Example 2, the performance of suppress stray light was higher than that of the optical element 3 according to Comparative Example 2, and in the optical element 5 according to Example 3, the performance of suppress stray light was higher than those of the optical element 3 according to Comparative Example 2 and the optical element 4 according to Example 2.

### Example 4

### <Preparation of Reflective Liquid Crystal Diffraction Element>

A cholesteric liquid crystal layer G2 was prepared using the same method as that of Example 1.

The photo-alignment film was exposed using the exposure device 60 shown in FIG. 9 to form an alignment film P-G3 having a predetermined alignment pattern using the same method as that of Example 3, except that in the exposure of the photo-alignment film of Example 3, the position of the lens 74 in FIG. 9 was moved in the in-plane arrangement axis D direction (X direction) from the position of the lens 74 in the disposition during the exposure for forming the alignment film P-G2.

A cholesteric liquid crystal layer G4 was formed using the same method as that of the formation of the cholesteric liquid crystal layer G3 according to Example 3, except that the alignment film P-G3 was used.

### <Preparation of Optical Element>

A laminate G2 including the cholesteric liquid crystal layer G2 and the temporary support and a laminate G4 including the cholesteric liquid crystal layer G4 and the temporary support were prepared using the same method as that of the preparation of the optical element according to Comparative Example 1, except that the cholesteric liquid crystal layer G1 was changed to the cholesteric liquid crystal layer G2 or the cholesteric liquid crystal layer G4.

Next, a glass substrate with an antireflection layer was separately prepared using the same method as that of Comparative Example 1, the laminate G4 was bonded to the glass substrate with the antireflection layer such that the cholesteric liquid crystal layer G4 came into contact with the surface opposite to the antireflection layer, and the temporary support was peeled off from the cholesteric liquid crystal layer G4. As in the above-described case, the laminate G2 was bonded to the cholesteric liquid crystal layer G4, and the temporary support was peeled off from the cholesteric liquid crystal layer G2. This way, an optical element 6 that was the laminate including the cholesteric liquid crystal layer G2, the cholesteric liquid crystal layer G4, the glass substrate, and the antireflection layer in this order was prepared.

### [Evaluation]

In a case where light was incident into the prepared optical element from an oblique direction (angle with respect to the normal line), the intensity of reflected light was evaluated.

Specifically, the prepared optical element was irradiated with laser light L having an output center wavelength of 532 nm from alight source. The incidence angle of the laser light was an angle of 65° from the normal direction of the prepared optical element. In addition, the laser light emitted from the light source was vertically incident into a circular polarization plate corresponding to the wavelength of the laser light to be converted into linearly polarized light, and the obtained linearly polarized light was incident from the liquid crystal diffraction element side into the optical element. This linearly polarized light was incident into each of the positions P1, P2, and P3 of the cholesteric liquid crystal layer in the reflective liquid crystal diffraction element to evaluate an intersection (focusing position) between the light components reflected from the respective positions.

Regarding the intersection (focusing position) in a case where light was incident into the respective positions (positions P1, P2, and P3) of the cholesteric liquid crystal layer, light was focused on one position in the optical element 2 according to Example 1. On the other hand, in the optical element 6 according to Example 4, light was focused on two different positions. This way, in the optical element 6 according to Example 4, the number of focusing positions of light was increased, and the effect of increasing Eyebox was verified.

### EXPLANATION OF REFERENCES

10, 10A, 10B, 10C: image display apparatus
12: image projection element
14: retardation plate
16: transparent substrate
18: polarization diffraction element
20: MEMS mirror
22: light guide plate
30: support
32: alignment film
34: cholesteric liquid crystal layer (liquid crystal layer)
40: liquid crystal compound
40A: optical axis
42: bright portion
44: dark portion
60: exposure device
62: laser
64: light source
65: λ/2 plate
68: polarization beam splitter
70a, 70B: mirror
72A, 72B: λ/4 plate
74: lens
A: virtual image
R: real scene
G_{R}: right circularly polarized light of green light
M: laser light
MA, MB: beam
P_{O}: linearly polarized light
P_{R}: right circularly polarized light
P_{L}: left circularly polarized light
U: user
D: arrangement axis
A: single period
P (tilted) surface pitch
PT: helical pitch

What is claimed is:

1. An image display apparatus comprising:
an image projection element; and
a reflective polarization diffraction element that reflects an image projected by the image projection element,
wherein the polarization diffraction element includes a cholesteric liquid crystal layer obtained by immobilizing a cholesteric liquid crystalline phase,
the cholesteric liquid crystal layer has a liquid crystal alignment pattern in which an orientation of an optical axis derived from a liquid crystal compound changes while continuously rotating in at least one in-plane direction,
in a case where a length over which the orientation of the optical axis derived from the liquid crystal compound in the one direction of the liquid crystal alignment pattern rotates by 180° is set as a single period, the cholesteric liquid crystal layer has a region where the length of the single period decreases in an in-plane direction away from the image projection element, and
the cholesteric liquid crystal layer has regions where a pitch of a helical structure in the cholesteric liquid crystal layer varies in a plane.

2. The image display apparatus according to claim 1,
wherein the cholesteric liquid crystal layer has a region where the length of the single period decreases in the in-plane direction away from the image projection element and the pitch of the helical structure in the cholesteric liquid crystal layer increases.

3. The image display apparatus according to claim 1,
wherein the cholesteric liquid crystal layer has a region where the length of the single period is less than 1.0 μm.

4. The image display apparatus according to claim 1,
wherein the polarization diffraction element includes a first cholesteric liquid crystal layer and a second cholesteric liquid crystal layer each of which is provided in the cholesteric liquid crystal layer, and
a rotation direction of the orientation of the optical axis that continuously rotates in the one direction in the liquid crystal alignment pattern of the first cholesteric liquid crystal layer is opposite to a rotation direction of the orientation of the optical axis that continuously rotates in the one direction in the liquid crystal alignment pattern of the second cholesteric liquid crystal layer, and
a turning direction of the helical structure in the first cholesteric liquid crystal layer is opposite to a turning direction of the helical structure in the second cholesteric liquid crystal layer.

5. The image display apparatus according to claim 4,
wherein a wavelength range of light that is selectively reflected from the first cholesteric liquid crystal layer overlaps a wavelength range of light that is selectively reflected from the second cholesteric liquid crystal layer.

6. The image display apparatus according to claim 1,
wherein the polarization diffraction element includes a first cholesteric liquid crystal layer, a second cholesteric liquid crystal layer, and a third cholesteric liquid crystal layer each of which is provided in the cholesteric liquid crystal layer,
in all of the first cholesteric liquid crystal layer, the second cholesteric liquid crystal layer, and the third cholesteric liquid crystal layer, lengths of the single periods are different from each other, and pitches of the helical structures are different from each other at any one in-plane point of the polarization diffraction element,
in a case where the lengths of the single periods of the first cholesteric liquid crystal layer, the second cholesteric liquid crystal layer, and the third cholesteric liquid crystal layer at the one in-plane point are represented by Λ₁, Λ₂, and Λ₃, respectively, Λ₁<Λ₂<Λ₃ is satisfied,
the first cholesteric liquid crystal layer has a region where blue light is diffracted,
the second cholesteric liquid crystal layer has a region where green light is diffracted, and
the third cholesteric liquid crystal layer has a region where red light is diffracted.

7. The image display apparatus according to claim 6,
wherein a rotation direction of the orientation of the optical axis that continuously rotates in the one direction in the liquid crystal alignment pattern of the first cholesteric liquid crystal layer is opposite to a rotation direction of the orientation of the optical axis that continuously rotates in the one direction in the liquid crystal alignment pattern of the second cholesteric liquid crystal layer, and is the same as a rotation direction of the orientation of the optical axis that continuously rotates in the one direction in the liquid crystal alignment pattern of the third cholesteric liquid crystal layer, and
a turning direction of the helical structure in the first cholesteric liquid crystal layer is opposite to a turning direction of the helical structure in the second cholesteric liquid crystal layer, and is the same as a turning direction of the helical structure in the third cholesteric liquid crystal layer.

8. AR glasses comprising:
the image display apparatus according to claim 1.

9. The image display apparatus according to claim 2,
wherein the polarization diffraction element includes a first cholesteric liquid crystal layer and a second cholesteric liquid crystal layer each of which is provided in the cholesteric liquid crystal layer, and
a rotation direction of the orientation of the optical axis that continuously rotates in the one direction in the liquid crystal alignment pattern of the first cholesteric liquid crystal layer is opposite to a rotation direction of the orientation of the optical axis that continuously rotates in the one direction in the liquid crystal alignment pattern of the second cholesteric liquid crystal layer, and
a turning direction of the helical structure in the first cholesteric liquid crystal layer is opposite to a turning direction of the helical structure in the second cholesteric liquid crystal layer.

10. The image display apparatus according to claim 2,
wherein the polarization diffraction element includes a first cholesteric liquid crystal layer, a second cholesteric liquid crystal layer, and a third cholesteric liquid crystal layer each of which is provided in the cholesteric liquid crystal layer,
in all of the first cholesteric liquid crystal layer, the second cholesteric liquid crystal layer, and the third cholesteric liquid crystal layer, lengths of the single periods are different from each other, and pitches of the helical structures are different from each other at any one in-plane point of the polarization diffraction element,
in a case where the lengths of the single periods of the first cholesteric liquid crystal layer, the second cholesteric liquid crystal layer, and the third cholesteric liquid crystal layer at the one in-plane point are represented by Λ₁, Λ₂, and Λ₃, respectively, Λ₁<Λ₂<Λ₃ is satisfied,
the first cholesteric liquid crystal layer has a region where blue light is diffracted,
the second cholesteric liquid crystal layer has a region where green light is diffracted, and
the third cholesteric liquid crystal layer has a region where red light is diffracted.

11. AR glasses comprising:
the image display apparatus according to claim 2.

12. The image display apparatus according to claim 3,
wherein the polarization diffraction element includes a first cholesteric liquid crystal layer and a second cholesteric liquid crystal layer each of which is provided in the cholesteric liquid crystal layer, and
a rotation direction of the orientation of the optical axis that continuously rotates in the one direction in the liquid crystal alignment pattern of the first cholesteric liquid crystal layer is opposite to a rotation direction of the orientation of the optical axis that continuously rotates in the one direction in the liquid crystal alignment pattern of the second cholesteric liquid crystal layer, and
a turning direction of the helical structure in the first cholesteric liquid crystal layer is opposite to a turning direction of the helical structure in the second cholesteric liquid crystal layer.

13. The image display apparatus according to claim 3,
wherein the polarization diffraction element includes a first cholesteric liquid crystal layer, a second cholesteric liquid crystal layer, and a third cholesteric liquid crystal layer each of which is provided in the cholesteric liquid crystal layer,
in all of the first cholesteric liquid crystal layer, the second cholesteric liquid crystal layer, and the third cholesteric liquid crystal layer, lengths of the single periods are different from each other, and pitches of the helical structures are different from each other at any one in-plane point of the polarization diffraction element,
in a case where the lengths of the single periods of the first cholesteric liquid crystal layer, the second cholesteric liquid crystal layer, and the third cholesteric liquid crystal layer at the one in-plane point are represented by Λ₁, Λ₂, and Λ₃, respectively, Λ₁<Λ₂<Λ₃ is satisfied,
the first cholesteric liquid crystal layer has a region where blue light is diffracted,
the second cholesteric liquid crystal layer has a region where green light is diffracted, and
the third cholesteric liquid crystal layer has a region where red light is diffracted.

14. AR glasses comprising:
the image display apparatus according to claim 3.

15. AR glasses comprising:
the image display apparatus according to claim 4.

16. AR glasses comprising:
the image display apparatus according to claim 5.

17. AR glasses comprising:
the image display apparatus according to claim 6.

18. AR glasses comprising:
the image display apparatus according to claim 7.
